(19) United States
(12) Patent Application Publication
(10) Pub. No.: US 2024/0249511 A1
(43) Pub. Date: Jul. 25, 2024

(54) VIDEO QUALITY ASSESSMENT METHOD AND APPARATUS, COMPUTER DEVICE, COMPUTER STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Guiliang GONG, Shenzhen (CN); Gaoxiong Yi, Shenzhen (CN)

(73) Assignee: TENCENT TECHNOLOGY (SHENZHEN) COMPANY LIMITED, Shenzhen (CN)

(21) Appl. No.: 18/624,763

(22) Filed: Apr. 2, 2024

Related U.S. Application Data
(63) Continuation of application No. PCT/CN2023/107878, filed on Jul. 18, 2023.

(30) Foreign Application Priority Data
Aug. 24, 2022 (CN) 202211018116.9

(51) Int. Cl. G06V 10/80; G06T 7/00; G06V 10/44; G06V 10/62; G06V 10/771

(52) U.S. Cl. CPC G06V 10/806; G06T 7/0002; G06V 10/44; G06V 10/62; G06V 10/771

(57) ABSTRACT

A video quality assessment method and apparatus including playing an online video stream, obtaining a time-domain feature of a corresponding unit of duration based on video playback fluency detected within at least one unit of duration in a process of playing the online video stream, extracting video frames from the online video stream, separately extracting a spatial-domain feature from each extracted video frame, obtaining a time-domain feature vector based on the time-domain feature of the unit of duration, obtaining a spatial-domain feature vector based on a corresponding spatial-domain feature of each video frame, performing feature fusion processing on the spatial-domain feature vector and the time-domain feature vector to obtain a fusion feature vector, and determining a video quality assessment value of the online video stream based on the fusion feature vector.

### CROSS-REFERENCE TO RELATED APPLICATIONS

This application is a continuation application of International Application No. PCT/CN2023/107878 filed on Jul. 18, 2023, which claims priority to Chinese Patent Application No. 202211018116.9 filed with the China National Intellectual Property Administration on Aug. 24, 2022, the disclosures of each being incorporated by reference herein in their entireties.

### FIELD

The disclosure relates to the field of computer technologies, and in particular, to the field of video technologies. A video quality assessment method and apparatus, a device, and a computer storage medium are provided.

### BACKGROUND

Online communication videos provide a convenient communication environment. Video quality determines user experience. The video quality is usually affected by many factors such as a terminal device, a physical environment, a network condition, and an encoder. Accurate video quality assessment is a prerequisite for downstream application such as codec tool optimization and low-quality scene analysis. In the related art, a communication video quality assessment method is mainly implemented by using an offline reference method. To be specific, outputted video quality is assessed by comparing a difference between expected input and actual output of the video, and a communication tool is reversely optimized.

However, in an actual scenario, online real-time video quality assessment is more in line with an actual effect and has practical value. However, in the related art, since there is no reference source in a case that online communication video quality is assessed, input data only has actual communication video data and a method with no reference can only be used, online video quality cannot be effectively measured.

### SUMMARY

Some embodiments provide a video quality assessment method and apparatus, a computer device, a computer-readable storage medium, and a computer program product for integrating features of an online video stream in spatial-domain and time-domain dimensions to express video quality of the online video stream, so that accuracy of video quality assessment is improved.

Some embodiments provide a video quality assessment method, performed by a computer device, including: playing an online video stream; obtaining a time-domain feature of a corresponding unit of duration based on video playback fluency detected within at least one unit of duration in a process of playing the online video stream; extracting video frames from the online video stream, and separately extracting a spatial-domain feature from each extracted video frame; obtaining a time-domain feature vector based on the time-domain feature of the unit of duration, and obtaining a spatial-domain feature vector based on a corresponding spatial-domain feature of each video frame; and performing feature fusion processing on the spatial-domain feature vector and the time-domain feature vector to obtain a fusion feature vector, and determining a video quality assessment value of the online video stream based on the fusion feature vector.

Some embodiments provide a video quality assessment apparatus, including: at least one memory configured to store program code; and at least one processor configured to read the program code and operate as instructed by the program code, the program code comprising:

Some embodiments further provide a non-transitory computer-readable storage medium, storing computer code which, when executed by at least one processor, causes the at least one processor to at least: play an online video stream; obtain a time-domain feature of a corresponding unit of duration based on video playback fluency detected within at least one unit of duration in a process of playing the online video stream; extract video frames from the online video stream, and separately extract a spatial-domain feature from each extracted video frame; obtain a time-domain feature vector based on the time-domain feature of the unit of duration, and obtain a spatial-domain feature vector based on a corresponding spatial-domain feature of each video frame; and perform feature fusion processing on the spatial-domain feature vector and the time-domain feature vector to obtain a fusion feature vector, and determine a video quality assessment value of the online video stream based on the fusion feature vector.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an application scenario according to some embodiments.

FIG. 2 is an entire flowchart of video quality assessment according to some embodiments.

FIG. 3 is a schematic flowchart of a method for training a video quality assessment model according to some embodiments.

FIG. 4 is a schematic diagram of training data collection according to some embodiments.

FIG. 5 is a schematic diagram of a structure of a video quality assessment model according to some embodiments.

FIG. 6 is a schematic flowchart of another training according to some embodiments.

FIG. 7 is a schematic diagram of an architecture using training sample groups for training according to some embodiments.

FIG. 8 is a schematic diagram of quality range distribution of video playback samples according to some embodiments.

FIG. 9 is a diagram of variation of rank_loss with a difference of quality prediction according to some embodiments.

FIG. 10 is a schematic flowchart of a video quality assessment method according to some embodiments.

FIG. 11 is a schematic diagram of continuously performing spatial-domain and time-domain feature extraction according to some embodiments.

FIG. 12 is a schematic diagram of a structure of a MobileNet-v3-small model according to some embodiments.

FIG. 13 is a schematic diagram of a structure of each bneck unit according to some embodiments.

FIG. 14 is a schematic flowchart of a video quality assessment method of an online video stream according to some embodiments.

FIG. 15 is a schematic flowchart of video quality assessment of an online video stream according to some embodiments.

FIG. 16 is a schematic diagram of a structure of a video quality assessment apparatus according to some embodiments.

FIG. 17 is a schematic diagram of a structure of an apparatus for training a video quality assessment model according to some embodiments.

FIG. 18 is a schematic diagram of a composition structure of a computer device according to some embodiments.

FIG. 19 is a schematic diagram of a composition structure of a computer device according to some embodiments.

### DESCRIPTION OF EMBODIMENTS

In embodiments of the disclosure, during playing an online video stream, a time-domain feature vector and a spatial-domain feature vector are obtained. Feature fusion processing is performed on the spatial-domain feature vector and the time-domain feature vector, and a video quality assessment value of the online video stream is determined based on a fusion feature vector. It may be learned that in various embodiments, features of an online video stream in both spatial-domain and time-domain dimensions are taken into account, and the features in the two dimensions are integrated to express video quality of the online video stream, so that accuracy of video quality assessment is improved.

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

It may be understood that in the following, data related to an online video stream is involved. In a case that various embodiments are applied to specific products or technologies, relevant permissions or consents are required. Collection, use, and processing of relevant data need to comply with relevant laws, regulations, and standards of relevant countries and regions.

For ease of understanding of the technical solutions provided herein, some key terms used in various embodiments are explained below.

Online video stream: It refers to real-time video data. For example, a video in some embodiments may be a real-time communication video, such as video communication and a video conference in instant messaging applications. Therefore, in this process, the video is played in the form of an online video stream. In other words, video data is received in real time and the video data is played in real time. In addition, its own video stream is sent to another party for playing to implement real-time video communication between at least two parties.

Spatial domain: It is also referred to as a space domain, that is, a pixel domain. Processing in the spatial domain is processing at a pixel level, such as overlap-add processing on a pixel-level image. In the field of video processing, the processing in the spatial domain, that is, for processing of a video image, a feature of the image is obtained, and image quality is represented.

Time domain: It is also referred to as a domain of time. In the time domain, an independent variable is time. To be specific, a horizontal axis of the time domain represents time, and a vertical axis of the time domain represents change of a signal. The time domain is used for describing values of the signal at different moments. In the field of video processing, a signal specifically refers to a freezing degree of a video. The time domain is used for describing values of the freezing degree of the video at different moments.

Gray-scale value-chroma (YUV) color space model: It is similar to a red-green-blue (RGB) model and the like. Both the two models are color space models. A difference is that different expression methods are used to express image information. The RGB model uses three primary colors of red, green, and blue in optics, and another color is blended by using different proportions of the three primary colors. “Y” in the YUV color space model represents luminance or luma, that is, a gray-scale value. “U” and “V” represent chrominance or chroma, are used for describing a color and saturation of an image, and are used for specifying a color of a pixel. It is precisely because YUV is a format that expresses a gray-scale value and chroma separately, so that the two do not interfere with each other. In addition, because human perception is not sensitive to chroma, during encoding a photo or a video, a chroma sampling rate may be reduced without greatly affecting image quality to reduce a chroma bandwidth. Therefore, YUV is usually used in various video processing components. For example, video transmission in an online video mostly uses the YUV color space model.

Embodiments of the disclosure relate to artificial intelligence and machine learning (ML) technologies.

Artificial intelligence (AI) is a theory, a method, a technology, and an application system that use a digital computer or a machine controlled by the digital computer to simulate, extend, and expand human intelligence, perceive an environment, obtain knowledge, and use knowledge to obtain an optimal result. In other words, the artificial intelligence is a comprehensive technology in computer science and attempts to understand the essence of intelligence and produce a new intelligent machine that can react in a manner similar to human intelligence. The artificial intelligence is to study the design principles and implementation methods of various intelligent machines, to enable the machines to have the functions of perception, reasoning, and decision-making.

Computer vision (CV) technology is a science that studies how to use a machine to “see”, and that the computer further refers to use a camera and a computer instead of human eyes to implement machine vision, such as recognition and measurement of a target, and further perform graphic processing, so that the computer processes the target into an image more suitable for human eyes to observe, or an image transmitted to an instrument for detection. As a scientific discipline, the computer vision technology studies related theories and technologies, and attempts to establish an artificial intelligence system that can obtain information from images or multidimensional data. The computer vision technology generally includes technologies such as image processing, image recognition, image semantic understanding, image retrieval, optical character recognition (OCR), video processing, video semantic understanding, video content/behavior recognition, three-dimensional object reconstruction, a 3D technology, virtual reality, augmented reality, synchronous positioning and map construction, autonomous driving, and smart transportation, and further includes biometric feature recognition technologies such as common face recognition and fingerprint recognition.

The machine learning is a core of the artificial intelligence, is a basic way to make the computer intelligent, and is applied to various fields of the artificial intelligence. The machine learning and deep learning generally include technologies such as an artificial neural network, a belief network, reinforcement learning, transfer learning, and inductive learning. An artificial neural network (ANN) abstracts a human brain neuron network from a perspective of information processing, establishes a specific simple model, and forms different networks according to different connection methods. A neural network is a computing model formed by a large quantity of nodes (or neurons) connected to each other. Each node represents a specific output function and is referred to as an activation function. A connection between every two nodes represents a weighted value for a signal passing through the connection, referred to as a weight. This is equivalent to a memory of the artificial neural network. Output of the network varies depending on a connection method of the network, a weight value, and the activation function. The network itself is generally an approximation of a specific algorithm or function in nature, or may be an expression of a logical policy.

With research and progress of an artificial intelligence technology, the artificial intelligence technology is studied and applied in a plurality of fields such as a common smart home, a smart wearable device, a virtual assistant, a smart speaker, smart marketing, self-driving, autonomous driving, an unmanned aerial vehicle, a robot, smart medical care, a smart customer service, Internet of Vehicles, autonomous driving, and smart transportation. It is believed that with the development of technologies, the artificial intelligence technology is applied in more fields and play increasingly important value.

The solutions provided in some embodiments relate to the machine learning of the artificial intelligence and technologies such as the computer vision technology. For example, in a case that quality assessment is performed on the online video stream, an artificial neural network model based on deep learning is needed. The artificial neural network model is constructed based on the computer vision technology. In some embodiments, a machine learning method is provided to obtain a video quality assessment model for quality assessment on the online video stream. The video quality assessment model achieves a capability to process and understand spatial-domain and time-domain features of the online video stream based on the machine learning and the computer vision technology, so that online video stream quality is measured based on this to obtain a quality assessment value of the online video stream.

Video quality assessment in various embodiments may be divided into two parts, including a training part and an application part. The training part relates to the field of machine learning technologies. In the training part, the artificial neural network model (that is, the video quality assessment model mentioned later) is trained by using the machine learning technology. The artificial neural network model is trained based on a video playback sample, and a parameter of the artificial neural network model is continuously adjusted by using an optimization algorithm until the artificial neural network model converges. In the application part, the artificial neural network model obtained by training in the training part is used to perform quality assessment on the online video stream during actual use. In addition, the artificial neural network model in some embodiments may be trained online or offline. This is not specifically limited herein. In this specification, offline training is used as an example.

A design idea of various embodiments is briefly described below.

Main difficulties in assessing online communication video quality are as follows.

Due to there being many models of terminal devices and each model having different computing capabilities, a video quality assessment algorithm needs to occupy as little storage and computing resources as possible in a case that an accuracy requirement is satisfied, to adapt to various models of terminal devices.

The video quality assessment algorithms in related art defaults that a video is smooth, so that video quality cannot be measured accurately.

Based on this, some embodiments provide a video quality assessment method and apparatus, a device, and computer storage medium. The method includes a lightweight spatio-temporal fusion real-time communication video quality assessment (LST-RTC VQA) algorithm, and includes: obtaining a time-domain feature of corresponding unit duration based on video playback fluency detected within each unit duration in a process of playing an online video stream; extracting video frames from the online video stream, and separately performing spatial-domain feature extraction on each extracted video frame (that is, a plurality of video frames or all video frames) to obtain a corresponding spatial-domain feature of each video frame; obtaining a time-domain feature vector based on each obtained time-domain feature, and obtaining a corresponding spatial-domain feature vector based on each obtained spatial-domain feature; and performing feature fusion processing on the spatial-domain feature vector and the time-domain feature vector to obtain a corresponding fusion feature vector, and determining a video quality assessment value of the online video stream based on the fusion feature vector. It may be learned that in some embodiments, features of an online video stream in both spatial-domain and time-domain dimensions are taken into account, and the features in the two dimensions are integrated to express video quality of the online video stream, so that accuracy of video quality assessment is improved. Some embodiments further implement real-time quality assessment of the online video stream, to improve real-time performance of quality assessment on the online video stream and facilitate assisting of optimization of the online video stream.

In addition, considering that the real-time quality assessment is applied to a video receive end, to not affect the online video quality as much as possible, video quality assessment is to occupy as little computing resources as possible. Therefore, in some embodiments, in a case that spatial-domain feature extraction is performed, feature extraction may be performed on a Y channel in a video stream in a YUV format to loss a small part of accuracy in exchange for only ⅓ of original computing amounts. In addition, for a time-domain dimension, to improve a computing speed, various embodiments mark a smooth frame with 1 and a freezing frame with 0 to form a time-domain binary stream as time-domain data input.

The following is a brief description to an application scenario applicable to the technical solutions of some embodiments. The application scenario described below is merely intended to describe various embodiments, but is not intended to be limiting. The technical solutions provided in various embodiments may be flexibly applied according to an actual requirement.

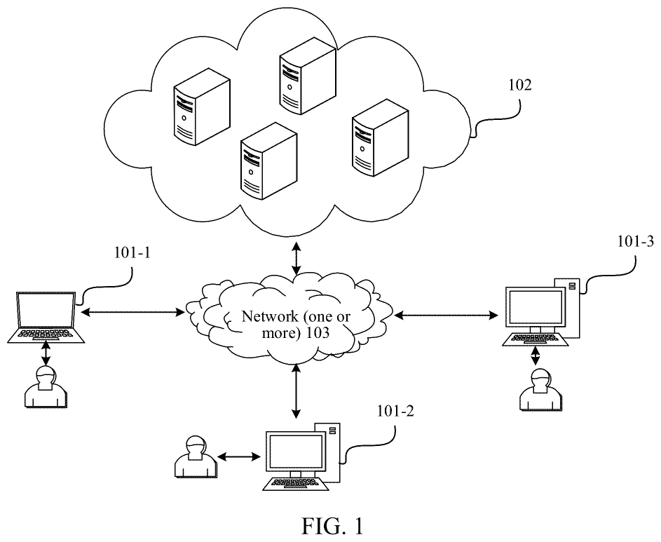

Some embodiments may be applied to various scenarios, including but not limited to a cloud technology, artificial intelligence, smart transportation, driver assistance, and the like. The solutions provided some embodiments may be applied to a video quality assessment part included in these scenarios, such as video quality assessment on video communication in an instant messaging application, an online video conference, and the like. FIG. 1 is a schematic diagram of an application scenario according to some embodiments. In the scenario, a terminal device and a server 102 may be included. There may be a plurality of terminal devices, such as a terminal device 101-1, a terminal device 101-2, and a terminal device 101-3 shown in FIG. 1. A quantity of the terminal devices is not limited. In some embodiments, a direct or indirect communication connection may be performed between each terminal device and the server 102 via one or more networks 103. The network 103 may be a wired network or a wireless network. For example, the wireless network may be a mobile cellular network or a wireless-fidelity (Wi-Fi) network, and certainly, may be another possible network. This is not limited herein.

The terminal device may be any computer device with video communication and a video quality assessment capability, such as a mobile phone, a tablet computer (PAD), a notebook computer, a desktop computer, an intelligent voice interaction device, a smart appliance, a smart vehicle-mounted device, an aircraft, and a smart wearable device. A video communication application such as an instant messaging application and an online videoconferencing application may be installed on the terminal device. An application involved in some embodiments may be a software client, or a client such as a web page or an applet. The server 102 is a server corresponding to software, the web page, the applet, and the like. A specific type of the client is not limited. The server 102 is a back-end server of a video communication application. The server 102 may be, for example, an independent physical server, a server cluster or a distributed system composed of a plurality of physical servers, or a cloud server that provides a basic cloud computing service such as a cloud service, a cloud database, cloud computing, a cloud function, cloud storage, a network service, a cloud communication, a middleware service, a domain name service, a security service, a content delivery network (CDN), and a big data and artificial intelligence platform, but is not limited thereto.

The video quality assessment method in some embodiments may be performed by the terminal device alone, by the server 102 alone, or by the server 102 and the terminal device jointly.

An example in which the terminal device performs the video quality assessment method alone is used. The terminal device obtains a time-domain feature of corresponding unit duration based on video playback fluency detected within each unit duration in a process of playing an online video stream; extracts video frames from the online video stream, and separately performs spatial-domain feature extraction on each extracted video frame to obtain a corresponding spatial-domain feature of each video frame; obtains a time-domain feature vector based on each obtained time-domain feature, and obtaining a corresponding spatial-domain feature vector based on each obtained spatial-domain feature; and performs feature fusion processing on the spatial-domain feature vector and the time-domain feature vector to obtain a corresponding fusion feature vector, and determines a video quality assessment value of the online video stream based on the fusion feature vector.

An example in which the server 102 performs the video quality assessment method alone is used. The terminal device records an online video stream played by itself in real time and sends the online video stream to the server 102. Then, the server 102 performs the video quality assessment method. The server 102 obtains a time-domain feature of corresponding unit duration based on video playback fluency detected within each unit duration; extracts video frames from the online video stream, and separately performs spatial-domain feature extraction on each extracted video frame to obtain a corresponding spatial-domain feature of each video frame; obtains a time-domain feature vector based on each obtained time-domain feature, and obtains a corresponding spatial-domain feature vector based on each obtained spatial-domain feature; and performs feature fusion processing on the spatial-domain feature vector and the time-domain feature vector to obtain a corresponding fusion feature vector, and determines a video quality assessment value of the online video stream based on the fusion feature vector.

An example in which the terminal device and the server 102 perform the video quality assessment method jointly is used. The terminal device obtains a time-domain feature of corresponding unit duration based on video playback fluency detected within each unit duration; extracts video frames from the online video stream, and separately performs spatial-domain feature extraction on each extracted video frame to obtain a corresponding spatial-domain feature of each video frame; sends the corresponding spatial-domain features of the video frame to the server 102. Further, the server 102 obtains a time-domain feature vector based on each obtained time-domain feature and obtains a corresponding spatial-domain feature vector based on each obtained spatial-domain feature, and performs feature fusion processing on the spatial-domain feature vector and the time-domain feature vector to obtain a corresponding fusion feature vector, and determines a video quality assessment value of the online video stream based on the fusion feature vector.

In some embodiments, the video quality assessment method may be applied to an online videoconferencing scenario. In the scenario, a plurality of video receive ends are involved, and video quality assessment may be performed at each video receive end. In addition, because online video stream data that needs to be collected and analyzed on the video receive end is involved in the foregoing video quality assessment, to implement a video quality assessment, a user of each video receive end may be requested to authorize a collection permission of relevant data. Further, with the permission, frame extraction is performed on the online video stream played on the video receive end to extract a spatial-domain feature, and a time-domain feature within each unit duration is determined in real time, to further comprehensively assess the video quality by integrating the spatial-domain and time-domain features, so that accuracy of video quality assessment is improved.

An implementation process of the video quality assessment method provided in some embodiments in other video communication scenarios is similar to that of the foregoing online videoconferencing scenario. Therefore, details are not described herein again.

The video quality assessment method provided in some embodiments is described below in combination with the above-described application scenario and the accompanying drawings. The above application scenario is only shown to facilitate understanding the principles of the disclosure. The implementations are not limited in this aspect.

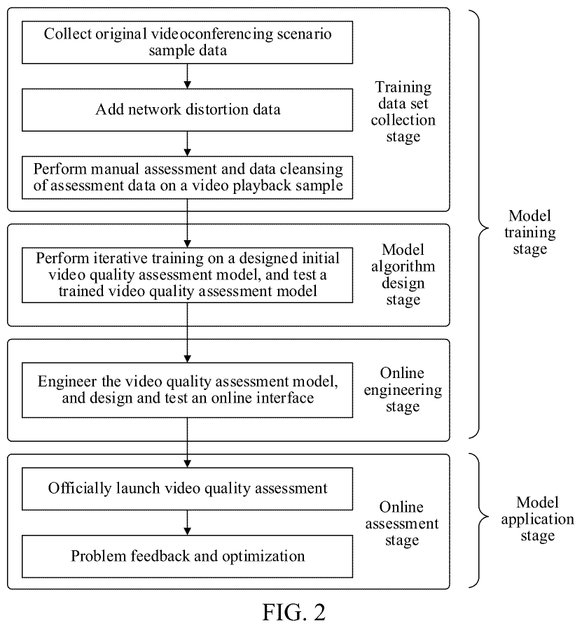

FIG. 2 is an entire flowchart of video quality assessment according to some embodiments. In the process, a model training stage and a model application stage are included. The model training stage includes stages, such as training data set collection, a model algorithm design, and online engineering. Using an online videoconferencing scenario as an example, in the training data set collection stage, original videoconferencing scenario sample data is collected, and network distortion data is added to obtain a video playback sample with a network distortion, to simulate to obtain a corresponding video playback sample in different network distortion environments. In addition, manual assessment and data cleansing of assessment data are performed on the video playback sample to obtain an assessment value that may be used for training. In the model algorithm design stage, iterative training is performed on a designed initial video quality assessment model by using the obtained video playback sample until the model reaches a convergence condition. In addition, a trained video quality assessment model is tested, and may be actually used online in a case that the test reaches a standard. In the online engineering stage, after the video quality assessment model is engineered and an online interface is designed and tested, the video quality assessment is officially launched, and a problem in an online quality assessment process is fed back and optimized to further optimize the video quality assessment model.

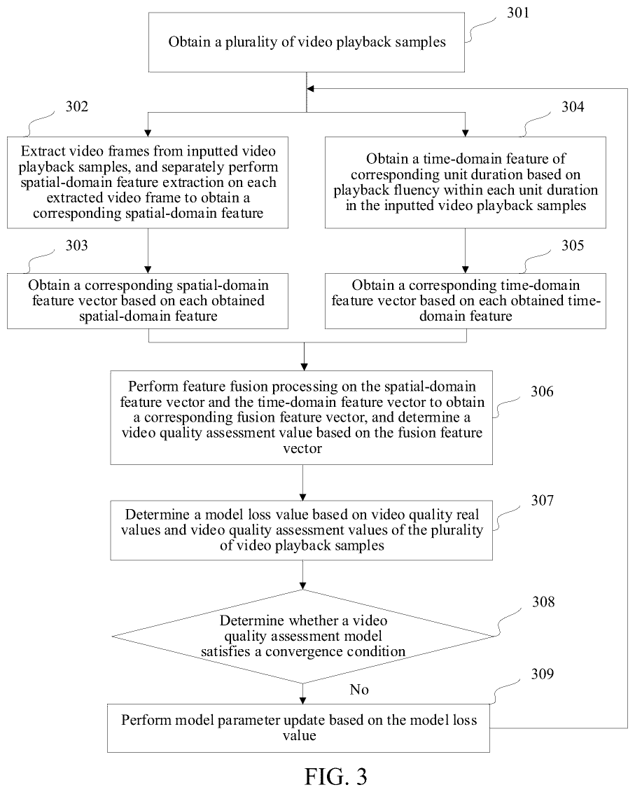

The stages are separately described below. Because the model needs to be trained in advance before officially putting into use, a training process of the video quality assessment model is described here first. FIG. 3 is a schematic flowchart of a method for training a video quality assessment model according to some embodiments. The method may be performed by a terminal device or a server. An implementation flow of the method is as the following operation 301 to operation 309.

Operation 301: Obtain a plurality of video playback samples.

In some embodiments, video playback samples may be formed by collecting video playback data in a real scenario and manually assessing.

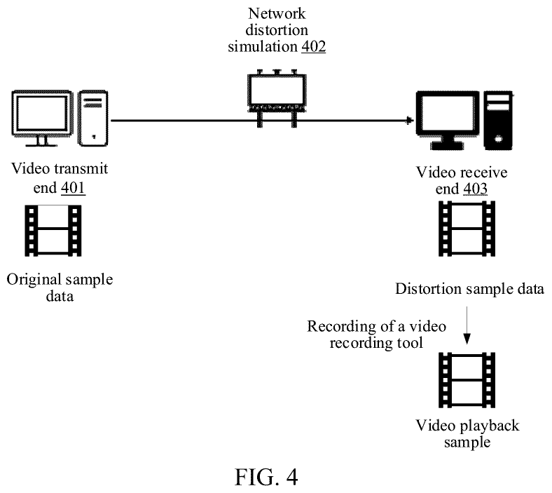

The plurality of video playback samples are obtained by recording an original video stream played by a video receive end under different video distortion simulation environments. Using an online videoconferencing scenario as an example, an original video stream is original conference scenario sample data. A plurality of pieces of original conference scenario sample data is first collected. Each piece of original conference scenario sample data is a short-duration conference video. For example, more than 250 conference videos with eight seconds to ten seconds may be collected. In an actual scenario, due to influence of a device or a network, a specific distortion to a video inevitably occurs during video transmission or video decoding and playing. Therefore, a plurality of types of (at least two) network distortions may be pre-designed, more than 20 types of network distortions, such as different videoconferencing software, speed limits at all levels, jitter, packet loss, and a combined distortion (that is, a distortion obtained by combining a plurality of distortions). Therefore, to obtain a real video playback sample at the video receive end, a video playback sample with these network distortions is added. Refer to FIG. 4. In some embodiments, a video transmit end 401 uses a virtual camera to participate in a video conference to play original sample data in a real scenario, and different network distortions are added to the original sample data in pre-designed different network distortion environments via network distortion simulation 402. Distortion sample data is presented at a video receive end 403 (in other words, the original sample data with a network distortion is added). In addition, video playback samples may be obtained by recording with a video recording tool (in other words, the original sample data with a network distortion is added). For example, the video recording tool such as ffmpeg may be used for recording.

For the obtained video playback samples, subjective scoring may be performed by using manual assessment. For example, 200 people may perform subjective scoring on the obtained video playback samples by using crowdsourcing scoring, ensuring that each video playback sample has rating data of more than 30 people to obtain effective average score statistics. Average score statistics of each video playback sample is used as a video quality real value of the video playback sample.

In some embodiments, in the foregoing scoring process, for each video playback sample, cleaning (which may be a deletion operation) is performed on scoring deviation data (an outlier) by using scoring distribution analysis, group scoring consistency, and deviation error analysis, and the like, to collect statistics about an average score of cleaned scoring data, and use the average score of each video playback sample as mean opinion score (MOS) data corresponding to each video playback sample. The scoring deviation data is scoring data of which difference from other scoring data is greater than a set threshold in the video playback sample. For example, the video playback sample has three pieces of scoring data, that is, 10, 11, and 20. If a difference between 20 and 11 is greater than a set threshold 5, 20 is the score deviation data.

In some embodiments, to avoid scoring errors, redundant videos may be provided in the video playback samples that each scorer needs to assess during a crowdsourcing scoring process. In other words, there are duplicate video playback samples in the video playback samples that each scorer needs to assess. After scoring data of the scorer is obtained, scoring consistency verification is performed based on the pre-set redundant videos. To be specific, it is verified whether scores of the scorer are consistent for the duplicate videos. If the scores of the scorer are inconsistent, it indicates that scoring data of the scorer is invalid and the scoring data of the scorer is deleted. If the scores of the scorer are consistent, after being used for subsequent data cleaning, scoring data of the scorer may be used as a data basis for calculating a MOS corresponding to each video playback sample.

According to the foregoing processing, a sample data set used for model training may be obtained. For example, for the foregoing more than 250 conference videos with eight seconds to ten seconds (combined with 20 types of network distortions), more than 4926 sample data sets including video playback samples may be obtained finally. A video quality real value corresponding to each video playback sample is the foregoing MOS.

In some embodiments, the plurality of video playback samples obtained above may be used to perform a plurality of times of iterative training. Because iterative processes are similar, an iterative process is used as an example for a detailed description here. During each iteration, the following operations are performed on inputted video playback samples at this time.

Operation 302: Extract video frames from the inputted video playback samples, separately perform spatial-domain feature extraction on each extracted video frame to obtain a corresponding spatial-domain feature.

In some embodiments, a video quality assessment model may extract video frames from the inputted video playback samples, and separately perform spatial-domain feature extraction on each extracted video frame (that is, a plurality of video frames or all video frames) to obtain a corresponding spatial-domain feature. The spatial-domain feature is a feature including spatial-domain information that represents the video frames. A model structure of the video quality assessment model is not limited herein. The video quality assessment model may be a deep neural network, a convolutional neural network, or the like.

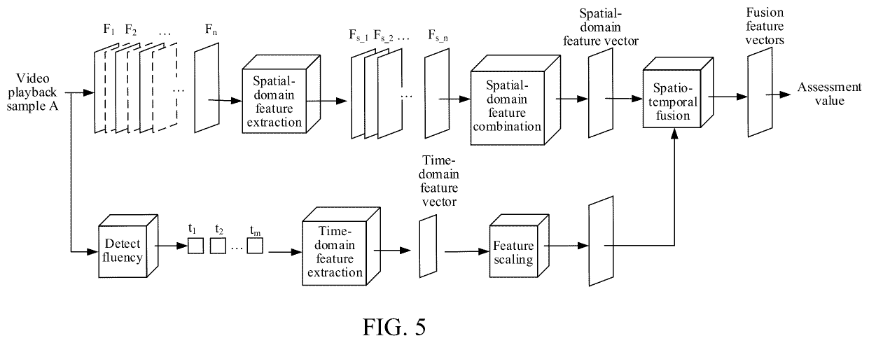

FIG. 5 is a schematic diagram of a structure of a video quality assessment model according to some embodiments. The video quality assessment model includes two branches (that is, a spatial-domain branch and a time-domain branch). Processing processes performed on video playback samples are similar, so that a video playback sample A is used as an example for description here.

For example, video frames are extracted from the video playback sample A. As shown in FIG. 5, video frames F₁ to Fₙ are extracted from the video playback sample A, and spatial-domain feature extraction is performed on the extracted video frames to obtain corresponding spatial-domain features, that is, F_{s_1} to F_{s_n} shown in FIG. 5.

In some embodiments, N frames may be extracted by using a manner of randomly extracting frames at equal intervals, and may be used as input of spatial-domain data (that is, video frames used for extracting the spatial-domain features).

In some embodiments, spatial-domain feature extraction may use any possible image feature extraction model, such as a visual geometry group (VGG) 16, a residual network (ResNet), a dense convolutional network (DenseNet), or a mobile network (MobileNet). This is not limited herein.

In some embodiments, considering processing efficiency and processing burden of a video receive end, a light MobileNet-v3-small model may be used as a spatial-domain feature extraction network (an image feature extraction model for spatial-domain feature extraction). To further reduce the processing processes, some embodiments use first front seven layers of the MobileNet-v3-small model as a basic network for spatial-domain feature extraction.

The MobileNet decomposes a general convolution into a depthwise separable convolution and 1×1 convolution. The depthwise separable convolution refers to that each channel of an inputted feature map corresponds to one convolution kernel. In this way, each channel of an outputted feature is only related to the channel corresponding to the inputted feature map. The depthwise separable convolution operation can significantly reduce a model size and a computing amount. The MobileNet-v3-small model has a depthwise separable convolution feature of MobileNetV1, the inverted residual with linear bottleneck of MobileNetV2, and a light attention model structure, and uses an activation function h-swish to replace an activation function swish in the MobileNet-v3-small model.

Operation 303: Obtain a corresponding spatial-domain feature vector based on each obtained spatial-domain feature.

In some embodiments, after the respective corresponding spatial-domain features of the extracted N frames are obtained, as shown in FIG. 5, a spatial-domain feature combination operation may be performed to obtain a corresponding spatial-domain feature vector. In other words, element-wise addition is performed on the respective corresponding spatial-domain features of the N frames to obtain the corresponding spatial-domain feature vector. For example, if a spatial-domain feature corresponding to a video frame is a 10×10 matrix, element-wise addition is performed on the respective corresponding spatial-domain features of the N frames to obtain a 10×10 spatial-domain feature vector.

Operation 304: Obtain a time-domain feature of corresponding unit duration based on playback fluency within each unit duration in inputted video playback samples.

In some embodiments, the unit duration (also referred to a unit of duration) may be specified according to an actual situation, for example, may be specified according to a frame rate of a video playback sample. As shown in FIG. 5, in a case that a frame rate of the video playback sample A is 30 frames per second, unit duration may be duration occupied by each frame, that is, 1/30 second. In some embodiments, the unit duration may be specified in another manner and is not limited herein.

In some embodiments, it may be determined whether the video playback sample A is freezing within each unit duration, and then each unit duration is marked. A time-domain feature of the unit duration is marked as a first value in a case that it is determined that a freezing result is smooth. A time-domain feature of the unit duration is marked as a second value in a case that it is determined that a freezing result is freezing. For example, in a case that a freezing result of the video playback sample A within unit duration is smooth, a time-domain feature of the unit duration is marked as 1. In a case that a freezing result of the video playback sample A within unit duration is freezing, a time-domain feature of the unit duration is marked as 0.

Operation 305: Obtain a corresponding time-domain feature vector based on each obtained time-domain feature (that is, a plurality of time-domain features or all time-domain features).

For example, the obtained time-domain features corresponding to the unit duration, that is, t₁ to tₘ shown in FIG. 5, are arranged in an order of the unit duration, a time-domain feature sequence (that is, a time-domain binary stream) synchronized with a playback progress may be obtained, and feature extraction is performed on the time-domain binary stream to obtain a corresponding time-domain feature vector.

Operation 306: Perform feature fusion processing on the spatial-domain feature vector and the time-domain feature vector to obtain a corresponding fusion feature vector, and determine a video quality assessment value based on the fusion feature vector.

Refer to FIG. 5. Considering that dimensions of the spatial-domain feature vector and the time-domain feature vector may be inconsistent, a feature scaling operation may be performed on the time-domain feature vector, so that a dimension of a scaled time-domain feature vector is consistent with the dimension of the spatial-domain feature vector. Then, feature fusion processing is performed on the scaled time-domain feature vector and the spatial-domain feature vector to obtain a corresponding fusion feature vector. In other words, element-wise addition is performed on the scaled time-domain feature vector and the spatial-domain feature vector to obtain the corresponding fusion feature vector.

Operation 307: Determine a model loss value based on video quality real values and video quality assessment values of the plurality of video playback samples.

In some embodiments, the model loss value may be calculated by using any possible loss function, such as a cross-entropy loss function, a zero-one loss function, or a mean absolute error loss (L1_loss) function.

Operation 308: Determine whether the video quality assessment model satisfies a convergence condition.

In some embodiments, the convergence condition may include at least one of the following: (1) the model loss value is not greater than a preset loss value threshold; and (2) a quantity of iterations reaches a preset quantity threshold.

Operation 309: If the determined result in operation 308 is “No”, perform model parameter update based on the model loss value, and use an updated video quality assessment model to enter a next training process until the video quality assessment model satisfies the convergence condition. The training process ends if the determination result of operation 308 is “Yes”.

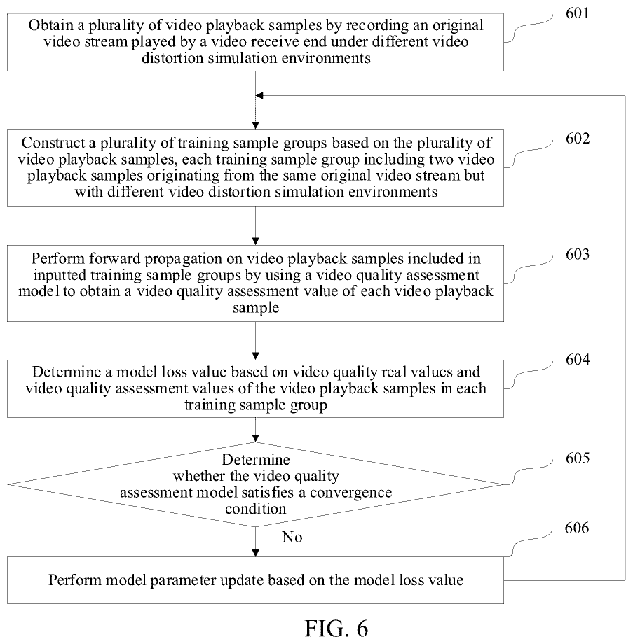

In some embodiments, to exclude a situation in which the video quality assessment model only learns monotonous quality information in video content and a video quality assessment result is caused to be inaccurate, for example, the video content may be the same, but predicted video quality assessment values are different, some embodiments use a plurality of training sample groups. Each training sample group includes two video playback samples originating from the same original video stream but with different video distortion simulation environments. A rank training learning idea is used to participate in the training process. FIG. 6 is a schematic flowchart of another training according to some embodiments, as shown in the following operation 601 to operation 606.

Operation 601: Obtain a plurality of video playback samples by recording an original video stream played by a video receive end under different video distortion simulation environments.

Operation 602: Construct a plurality of training sample groups based on the plurality of video playback samples, each training sample group including two video playback samples originating from the same original video stream but with different video distortion simulation environments.

For example, there are a plurality of video playback samples from the same original video stream in different video distortion simulation environments among these video playback samples, so that these same original video playback samples may be combined in pair to obtain corresponding training sample groups. Further, these training sample groups are used to perform a plurality of times of iterative training on the video quality assessment model, so that each input is the plurality of training sample groups.

Operation 603: Perform forward propagation on the video playback samples included in the inputted training sample groups by using the video quality assessment model to obtain video quality assessment values of the video playback samples (that is, the plurality of video playback samples or all video playback samples).

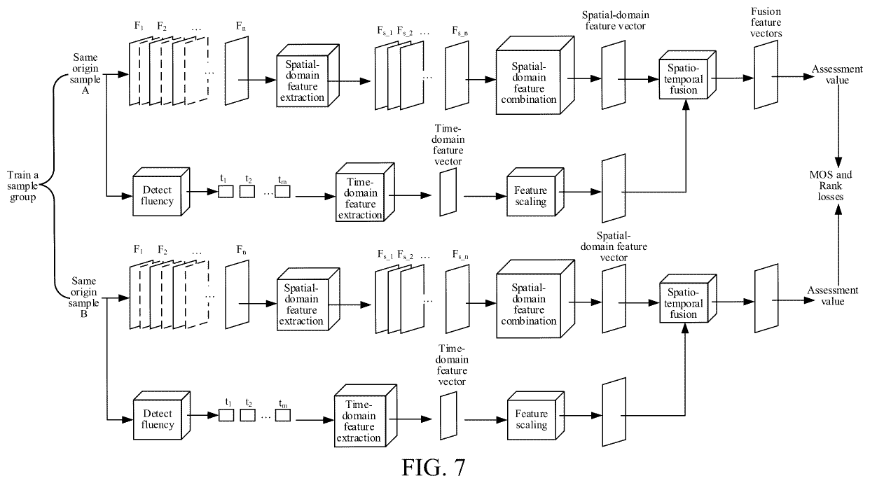

FIG. 7 is a schematic diagram of an architecture using training sample groups for training. Each training sample group includes a same origin sample A and a same origin sample B. Parameters of the video quality assessment model respectively corresponding to the same origin sample A and the same origin sample B are the same. Further, forward propagation is separately performed on the same origin sample A and the same origin sample B by using the video quality assessment model to obtain a video quality assessment value of the same origin sample A and a video quality assessment value of the same origin sample B.

Because a process of the forward propagation is similar to the embodiment shown in FIG. 3, for description, refer to the embodiment in FIG. 3. Details are not described again herein.

Operation 604: Determine a model loss value based on video quality real values and video quality assessment values of the video playback samples in the training sample groups (that is, a plurality of training sample groups or all training sample groups).

For example, a model loss value for this training is determined based on a difference between video quality real values and a difference between video quality assessment values of two video playback samples in each training sample group.

In some embodiments, operation 604 may be implemented by the following manner: determining a quality assessment loss value based on the video quality real values and the video quality assessment values of the video playback samples (that is, a plurality of video playback samples or all video playback samples); determining a quality rank real value of the training sample group based on video quality real values of the two video playback samples in each training sample group (that is, a plurality of training sample groups or all training sample groups), and determining a quality rank loss value based on a difference between video quality assessment values of the two video playback samples as well as the quality rank real value; determining a quality classification loss value based on a difference between a video quality real value and a video quality assessment value of each video playback samples; and determining the model loss value based on the quality assessment loss value, the quality rank loss value, and the quality classification loss value.

For example, after the quality assessment loss value, the quality rank loss value, and the quality classification loss value are determined, weighted summation may be performed on the quality assessment loss value, the quality rank loss value, and the quality classification loss value to obtain the model loss value. For example, the following Formula (1) may be used to determine the model loss value Loss for this training:

$$Loss = {l}_{1} \_loss + 0.5 rank\_loss + 0.001 classffication\_loss \qquad ( 1 )$$

l₁_loss indicates a quality assessment loss value of each video playback sample in the training sample groups, and may be determined based on the video quality real values and the video quality assessment values of the video playback samples (that is, a plurality of video playback samples or all video playback samples).rank_loss indicates a quality rank loss value. A quality rank real value of the training sample group may be determined based on video quality real values of the two video playback samples in each training sample group, and the quality rank loss value is determined based on a difference between video quality assessment values of the two video playback samples as well as the quality rank real value. classffication_loss indicates a quality classification loss value, and may be determined based on a difference between the video quality real values and the video quality assessment values of the video playback samples.

The following describes the quality assessment loss value l₁_loss of the video playback samples in the training sample groups in Formula (1).

In some embodiments, the model loss value of this training may be determined based on ranking of the video quality real values and ranking of the video quality assessment values of the video playback samples in the training sample groups. For example, in the ranking of the video quality real values, the same origin sample A is located in front of the same origin sample B. In theory, in the ranking of the video quality assessment values, the same origin sample A is to be located in front of the same origin sample B, so that model parameter may be constrained based on this.

In some embodiments, l₁_loss may be calculated by using the following Formula (2):

$${l}_{1} \_loss = \frac{1}{N} {\sum }_{i = 1}^{N} \vert {y}_{i} - f ( {x}_{i} ) \vert \qquad ( 2 )$$

yᵢ indicates a video quality real value of a video playback sample. ƒ(xᵢ) indicates a video quality assessment value of a video playback sample. N indicates a quantity of video playback samples inputted this time. Certainly, the quality assessment loss value may be calculated in another manner, such as a cross-entropy loss function or a zero-one loss function. This is not limited herein.

The following describes the quality rank loss value rank_loss of the training sample group in Formula (1).

rank_loss may be determined based on the ranking of the video quality real values and the ranking of the video quality assessment values of the video playback samples in each training sample groups.

In some embodiments, a quality rank real value of the training sample group may be determined based on video quality real values of two video playback samples in each training sample group, and a quality rank loss value of the training sample group is determined based on a difference between video quality assessment values of the two video playback samples as well as the quality rank real value.

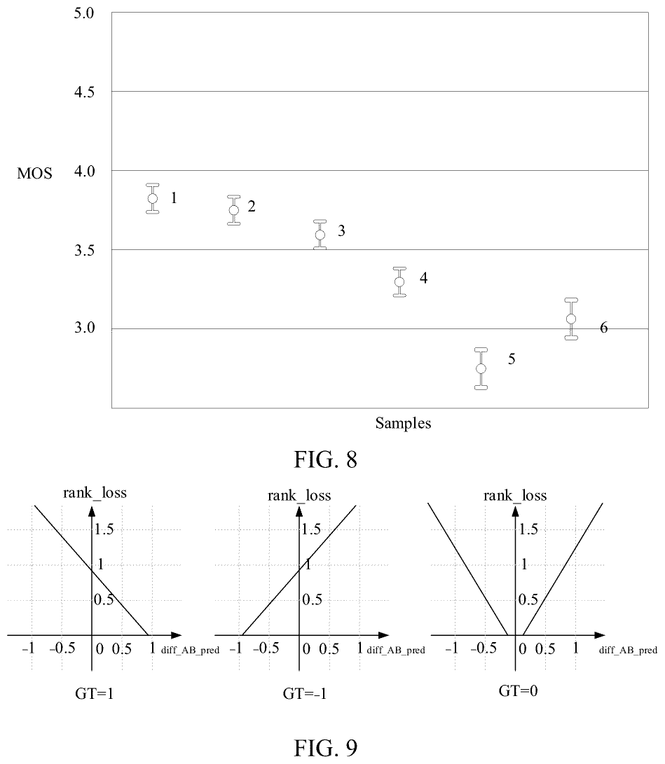

As an example of determining the quality rank real value, in a case that a quality rank label (that is, the true quality rank real value) of each training sample group is designed, a quality score range, that is, [MOS-1.96δ, MOS+1.968], of a single video playback sample in each training sample group is determined based on a preset confidence (using 95% as an example). FIG. 8 is a schematic diagram of quality score range distribution of video playback samples. It may be learned that upper limits and lower limits of quality score ranges of different video playback samples are different, and the quality rank label may be set by using the following Formula (3):

$$A - B MOS rank label \{ \begin{matrix}1 , {MOS}_{A} - 1.96 {δ}_{A} > {MOS}_{B} + 1.96 {δ}_{B} \\ - 1 , {MOS}_{A} + 1.96 {δ}_{A} < {MOS}_{B} - 1.96 {δ}_{B} \\ 0 , other\end{matrix} \qquad ( 3 )$$

In a case that a lower limit of a score range of the same origin sample A is greater than an upper limit of the same origin sample B, that is, video quality of the same origin sample A is better than that of the same origin sample B, a quality rank label A-B MOS rank label is 1. For example, for a sample No. 3 and a sample No. 4 in FIG. 8, a lower limit of the sample No. 3 is significantly greater than an upper limit of the sample No. 4, so that a quality rank label of a training sample group including the sample No. 3 and the sample No. 4 is 1. In a case that an upper limit of a score range of the same origin sample A is less than a lower limit of the same origin sample B, that is, video quality of the same origin sample A is worse than that of the same origin sample B, a quality rank label A-B MOS rank label is −1. For example, for a sample No. 5 and a sample No. 6 in FIG. 8, an upper limit of the sample No. 5 is significantly less than a lower limit of the sample No. 6, so that a quality rank label of a training sample group including the sample No. 5 and the sample No. 6 is −1. In a case that there is another case, it indicates that score ranges of the same origin sample A and the same origin sample B overlap, so that quality of the same origin sample A and the same origin sample B is subjectively difficult to distinguish, and the quality ranking label is 0. For example, in a case that the sample No. 1 and the sample No. 2 in FIG. 8 overlap, the quality rank label of the training sample group including the sample No. 1 and the sample No. 2 is 0.

To further simplify a label calculation process, the quality rank label of each training sample group may be determined by a difference between the video quality real values of the two same origin samples included. In other words, in a case that the difference between the video quality real values of the same origin sample A and the same origin sample B is greater than a preset upper limit threshold, the quality rank label of the training sample group is 1. In a case that the difference between the video quality real values of the same origin sample A and the same origin sample B is less than a preset lower limit threshold, the quality rank label of the training sample group is −1. Otherwise, the quality rank label of the training sample group is 0. Values of the preset upper limit threshold and the preset lower limit threshold may respectively be, for example, 1 and −1, or, may be other possible values. This is not limited herein.

As an example of determining the quality rank loss value of the training sample group based on the difference between the video quality assessment values of the two video playback samples as well as the quality rank real value, in a case that A-B MOS rank label is 1 or −1, rank_loss may be calculated by using the following Formula (4):

$$rank\_loss = max ( m - {diff}_{{AB}_{pred}} * GT , 0 ) \qquad ( 4 )$$

diff_AB_pred is the difference between the video quality assessment values of the two video playback samples in the same training sample group. GT is the quality rank label, that is the foregoing A-B MOS rank label, max represents taking a maximum value, m is a deviation tolerance, for example, may be set to 0.9.

In a case that A-B MOS rank label is 0, rank_loss may be calculated by using the following Formula (5):

$$rank\_loss = maax ( - ( 1 - m ) - {diff}_{{AB}_{pred}} * ( 1 - GT ) , - ( 1 - m ) - {diff}_{{AB}_{pred}} * ( - 1 - GT ) , 0 ) \qquad ( 5 )$$

diff_AB_pred is the difference between the video quality assessment values of the two video playback samples in the same training sample group. GT is the quality rank label, that is the foregoing A-B MOS rank label, max represents taking a maximum value, m is a deviation tolerance, for example, may be set to 0.9.

FIG. 9 is a diagram of variation of rank_loss with diff_AB_pred at different GT values. In a case that GT is 1 and a difference between video quality assessment values of two video playback samples in the same training sample group is greater than 0.9, rank_loss is 0, and a greater negative difference indicates a greater rank_loss. In a case that GT is −1 and a difference between video quality assessment values of two video playback samples in the same training sample group is less than −0.9, rank_loss is 0, and a greater positive difference indicates a greater rank_loss. In a case that GT is 0 and a difference between video quality assessment values of two video playback samples in the same training sample group is located between [−0.1, 0.1], rank_loss is 0, and a greater bidirectional difference indicates a greater rank_loss.

The following describes the quality classification loss value classffication_loss in Formula (1).

Considering that in an actual scenario, the video quality assessment values are usually divided into grades, for example, into five grades [1, 2, 3, 4, 5]. Therefore, a process of model learning quality scoring is also a classification problem to a specific extent, so that classification loss may be added to constrain during final outputting of a full connection layer of the model. The quality classification loss value may be determined based on a difference between a video quality real value and a video quality assessment value of each video playback sample.

As an example of determining the quality classification loss value based on a difference between a video quality real value and a video quality assessment value of each video playback sample, classification_loss may be calculated by using the following Formula (6):

$$classification\_loss = max ( 0 , \vert f ( {x}_{i} ) - {y}_{i} \vert - margin ) \qquad ( 6 )$$

yᵢ indicates a video quality real value of a video playback sample. ƒ(xᵢ) indicates a video quality assessment value of a video playback sample. margin is a deviation tolerance. For example, taking margin as 0.5, it means that if |ƒ(xᵢ)−yᵢ|<0.5, loss=0, that is, there is no classification loss, the video quality assessment values are accurately classified.

In some embodiments, in each iteration process, video playback samples may also be inputted in batches. To accelerate convergence, batch linear loss (plcc_loss) may also be added to constraint each batch training, so that the model loss value in operation 604 may also be calculated by the following Formula (7):

$$Loss = {l}_{1} \_loss + 0.5 rank\_loss + 0.001 classffication\_loss + 0.02 plcc\_loss \qquad ( 7 )$$

l₁_loss indicates the quality assessment loss value of the video playback samples in the training sample group. rank_loss indicates the quality rank loss value. classffication_loss indicates the quality classification loss value. plcc_loss indicates the batch linear loss. A weighting coefficient of each item in the foregoing formula may be a debugged empirical value. Certainly, another possible value may also be adjusted according to a situation. This is not limited herein.

The following describes plcc_loss.

In some embodiments, a determining process of plcc_loss includes: determining a first mean value of video quality real values of a plurality of video playback samples inputted in this batch, and determining a second mean value of video quality assessment values of the inputted plurality of video playback samples; performing the following processing on each of the video playback samples: determining a first difference between a video quality real value of the video playback sample and the first mean value, and determining a second difference between a video quality assessment value of the video playback sample and the second mean value; and determining a batch linear loss value of each video playback sample based on a first difference value and a second difference value corresponding to the video playback sample.

For example, the following Formula (8) may be used to calculate plcc_loss:

$$plcc\_loss = \frac{{\sum }_{i = 1}^{N} ( f ( {x}_{i} ) - \overline{f ( {x}_{ι} )} ) ( {y}_{i} - \overline{{y}_{ι}} )}{\sqrt{{\sum }_{i = 1}^{N} {( f ( {x}_{i} ) - \overline{f ( {x}_{ι} )} )}^{2}} \sqrt{{\sum }_{i = 1}^{N} {( {y}_{i} - \overline{{y}_{ι}} )}^{2}}} \qquad ( 8 )$$

yᵢ indicates a video quality real value of a video playback sample. ƒ(xᵢ) indicates a video quality assessment value of a video playback sample. y̅ᵢ̅ indicates the first mean value of the video quality real values of the video playback samples inputted in this batch. ƒ̅(̅x̅ₗ̅)̅ indicates the second mean value of the video quality assessment values of the video playback samples inputted in this batch. N is a quantity of the video playback samples inputted in this batch.

Operation 605: Determine whether the video quality assessment model satisfies a convergence condition.

Operation 606: If the determined result in operation 605 is “No”, perform model parameter update based on the model loss value, and use an updated video quality assessment model to enter a next training process until the video quality assessment model satisfies the convergence condition. The training process ends if the determination result of operation 605 is “Yes”.

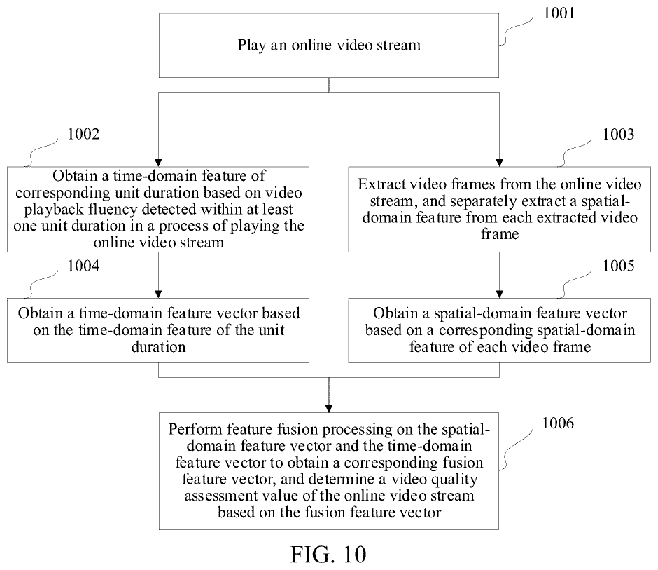

Heretofore, the training process of the video quality assessment model ends. After a trained video quality assessment model is engineered and an online interface is designed and tested, the trained video quality assessment model may be used in video quality assessment in actual scenarios, that is, enter the model application stage. Therefore, some embodiments further provide a video quality assessment method. FIG. 10 is a schematic flowchart of the video quality assessment method. The flow of the method includes the following operation 1001 to operation 1006.

Operation 1001: Play an online video stream.

During online video quality assessment, the online video stream is received and played in real time. In other words, in a case that a video receive end receives video data in this video communication process, the online video stream is played based on the video data.

Operation 1002: Obtain a time-domain feature of corresponding unit duration based on video playback fluency detected within at least one unit duration in a process of playing the online video stream.

The time-domain feature includes a time-domain fluency feature. The time-domain feature within the unit duration is used for representing video playback fluency detected within the unit duration.

In some embodiments, a time-domain feature of corresponding unit duration is obtained based on video playback fluency detected within each unit duration in a process of playing the online video stream.

In some embodiments, operation 1002 may be implemented by the following manner: performing the following processing on each unit duration: determining the video playback fluency within the unit duration based on a difference between a video frame played in the unit duration and a video frame played in at least one historical unit duration closest to the unit duration; and marking the unit duration based on the video playback fluency to obtain the time-domain feature to the corresponding unit duration, the time-domain feature of the unit duration being marked as a first value in a case that it is determined that the video playback fluency is smooth, and the time-domain feature of the unit duration being marked as a second value in a case that it is determined that the video playback fluency is freezing.

In some embodiments, for each unit duration, the following operations are performed to determine a freezing result (that is, fluency, detected video playback fluency). Using the current unit duration as an example, the freezing result (that is, whether freezing occurs) within the current unit duration may be determined based on a difference between a video frame played in the current unit duration and a video frame played in at least one historical unit duration closest to the current unit duration. For example, a currently played video frame is compared with a video frame played in previous unit duration to obtain a frame difference between the two video frames, and the frame difference after being binarized is compared with a preset frame difference threshold. If the binarized frame difference is less than the frame difference threshold, it indicates that the front frame and the next frame are the same, and it is determined that freezing occurs, otherwise it is determined to be smooth.

Further, the current unit duration is marked based on the freezing result of whether there is freezing to obtain a corresponding time-domain feature. A first value is marked in a case that it is determined that a freezing result is smooth. A second value is marked in a case that it is determined that a freezing result is freezing.

The current video playback fluency is detected to generate a time-domain feature of the current unit duration within each unit duration in a process of playing an online video stream. To be specific, it is necessary to determine whether freezing occurs in the current video stream. If freezing occurs, the current frame is a freezing frame, and the current frame is marked as the second value. If no freezing occurs, the current frame is a smooth frame, and the current frame is marked as the first value. The “frame” here does not refer to a video frame, but a time frame in a time domain. To be specific, time is divided into a plurality of frames in the time domain.

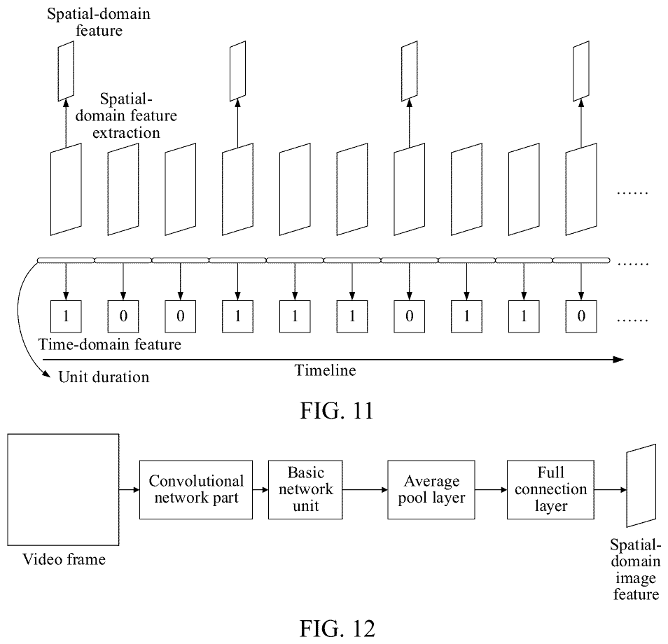

FIG. 11 is a schematic diagram of performing spatial-domain and time-domain feature extraction. In FIG. 11, an example in which each unit duration is display duration of a video frame is used. In a process of playing an online video stream, fluency of each unit duration is detected. The video frame is marked as 1 in a case that the video frame is a smooth frame, and the video frame is marked as 0 in a case that the video frame is a freezing frame. For example, in FIG. 11, the video frame is smooth within the first unit duration, so that the video frame is marked as 1. Freezing occurs in the second unit duration and the third unit duration, so that video frames are marked as 0 within the second unit duration and the third unit duration, and so on.

Operation 1003: Extract video frames from the online video stream, and separately extract a spatial-domain feature from each extracted video frames.

The spatial-domain feature includes a spatial-domain image feature.

In some embodiments, spatial-domain feature extraction is separately performed on each extracted video frame (that is, a plurality of video frames or all video frames) to obtain a corresponding spatial-domain feature of each video frame.

Refer to FIG. 11. In the process of playing the online video stream, frame extraction processing is performed on the video stream. For example, the frame extraction processing may be performed by using a manner of randomly extracting frames at equal intervals. An example in which the online video stream is played frame-by-frame is used. In some embodiments, a video clip of the online video stream may be obtained, and then frame extraction processing and spatial-domain feature extraction are performed on the video clip.

It is considered that an online scoring logic is different from that of offline training. In other words, data is not inputted as a whole video but inputted frame by frame. Therefore, to reduce online occupancy, after extraction and spatial-domain feature extraction are performed on a video frame, video frame extraction and spatial-domain feature extraction are performed again in a case that a frame interval reaches a set duration threshold.

In some embodiments, spatial-domain feature extraction processing of operation 1003 may be implemented by the following manner: performing the following processing on any one of the video frames: performing basic feature extraction on the video frame by a convolutional neural network unit to obtain an initial feature map of the video frame; inputting the initial feature map to a plurality of consecutive basic mobile network units; performing hierarchical feature extraction by using a plurality of consecutive basic mobile network units; and determining the spatial-domain feature based on a feature map outputted by the last basic mobile network unit.

In some embodiments, spatial-domain feature extraction processing of operation 1003 may be implemented by the following manner: performing the following processing on each video frame: performing basic feature extraction on the video frame by a convolutional neural network unit to obtain an initial feature map of the video frame; inputting the initial feature map to a plurality of consecutive basic mobile network units; performing hierarchical feature extraction by using a plurality of consecutive basic mobile network units; and determining the spatial-domain feature based on a feature map outputted by the last basic mobile network unit.

In some embodiments, spatial-domain feature extraction processing of operation 1003 may be implemented by the following manner: separately performing the following processing on the plurality of video frames (that is, some video frames in all video frames): performing basic feature extraction on the video frame by a convolutional neural network unit to obtain an initial feature map of the video frame; inputting the initial feature map to a plurality of consecutive basic mobile network units; performing hierarchical feature extraction by using a plurality of consecutive basic mobile network units; and determining the spatial-domain feature based on a feature map outputted by the last basic mobile network unit.

Basic feature extraction is performed on the video frame by a convolutional neural network unit to obtain an initial feature map of the video frame. The initial feature map outputted by the convolutional neural network is inputted to a plurality of consecutive basic mobile network units. In other words, the initial feature map outputted by the convolutional neural network is input of the plurality of consecutive basic mobile network units. Hierarchical feature extraction is performed on the initial feature map by using the plurality of consecutive basic mobile network units. In other words, any one of the plurality of consecutive basic mobile network units performs feature extraction on the feature map inputted to any one of the basic mobile network units. Output of any one of the basic mobile network units is used as input of the next mobile network unit to implement hierarchical feature extraction. Input of the first basic mobile network unit is the initial feature map. The spatial-domain feature is determined based on a feature map outputted by the last basic mobile network unit.

An example in which a MobileNet-v3-small model is used as a spatial-domain feature extraction model is used. FIG. 12 is a schematic diagram of a structure of the MobileNet-v3-small model. The MobileNet-v3-small model includes a convolutional neural network unit, a basic network (bneck) unit, an average pool (avg_pool) layer, and a full connection layer. There may be a plurality of bneck units. In some embodiments, first front seven layers may be selected as the spatial-domain feature extraction model. For each video frame, a process of spatial-domain feature extraction includes the following processing. Using a video frame as an example, basic feature extraction is performed on the video frame by using the convolutional neural network unit to obtain an initial feature map of the video frame. Further, the initial feature map is inputted to the bneck unit, and after the feature map outputted by the bneck unit is processed through the avg_pool layer and the full connection layer, a spatial-domain feature is obtained. Certainly, the feature map outputted by the bneck unit may be used as the spatial-domain feature directly.

In some embodiments, the following processing is performed by using each basic mobile network unit: performing dimensionality augmentation processing on a feature map inputted to the basic mobile network unit to obtain a first intermediate feature map, preferably performing depthwise separable convolution processing on the first intermediate feature map to obtain a second intermediate feature map, preferably further performing attention mechanism-based processing on the second intermediate feature map to obtain a third intermediate feature map, and preferably further performing residual processing on the third intermediate feature map and the feature map inputted to the basic mobile network unit to obtain a feature map outputted by the basic mobile network unit.

For example, the following processing is performed by using each basic mobile network unit: performing dimensionality augmentation processing on a feature map inputted to the basic mobile network unit to obtain a first intermediate feature map, performing depthwise separable convolution processing on the first intermediate feature map to obtain a second intermediate feature map, performing attention mechanism-based processing on the second intermediate feature map to obtain a third intermediate feature map, and performing residual processing on the third intermediate feature map and the feature map inputted to the basic mobile network unit to obtain a feature map outputted by the basic mobile network unit.

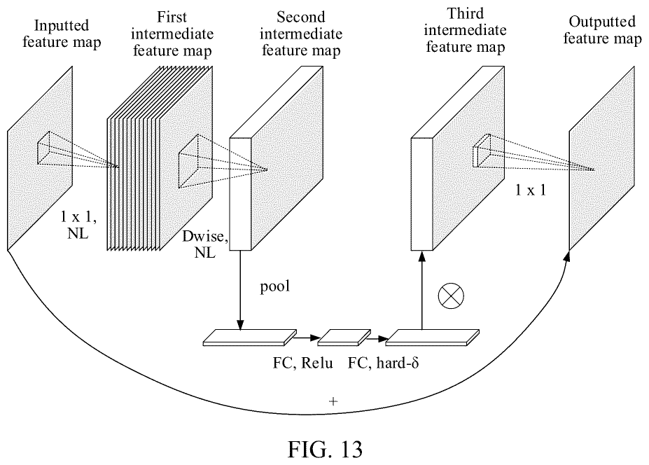

FIG. 13 is a schematic diagram of a structure of each bneck unit. The bneck unit has characteristics, such as the inverted residual with linear bottleneck, depthwise separable convolutions, light attention mechanism, and the use of h-swish activation function. For example, refer to FIG. 13. After a feature map is inputted, dimensionality augmentation processing is performed on the inputted feature map by using a 1×1 convolution to obtain a first intermediate feature map, and then subsequent operations are performed. A 3×3 depthwise separable convolution operation is performed on the first intermediate feature map to obtain a second intermediate feature map. Light attention mechanism processing is performed on the second intermediate feature map to obtain a third intermediate feature map, and residual processing is performed, by using the inverted residual with linear bottleneck, on the third intermediate feature map and the feature map inputted to the basic mobile network unit to obtain an outputted feature map. The light attention mechanism works by adjusting a weight of each channel, and in the foregoing processes, in a case that the activation function is related, a h-swish activation function is used, thereby reducing computing amount and improving performance. The inputted feature map of the first bneck unit is an initial feature map, and the inputted feature map of the subsequent bneck unit is an outputted feature map of the previous bneck unit.

In some embodiments, basic feature extraction being performed on a video frame by using the convolutional neural network unit may be implemented by the following manner: obtaining image data corresponding to a gray-scale value channel from image data of a plurality of channels corresponding to the video frame, the plurality of channels including the gray-scale value channel and a chroma channel; and performing basic feature extraction on the image data corresponding to the gray-scale value channel by using the convolutional neural network unit to obtain the initial feature map.

Considering that being applied to a video receive end, in a case that accuracy is not greatly affected, it is better that a less and faster computing amount of the online model. In addition, actual online data is a bare stream in a YUV format, and additional computational overhead is needed to convert a format, so that performance, a size of the application model, and an actual online data source are considered comprehensively. Therefore, in some embodiments, in a case that spatial-domain feature extraction is performed, the feature extraction is directly performed on a Y channel of a video stream in the YUV format. For example, an inputted size is 360×360, so that a small loss of accuracy exchange for only ⅓ of original computing amounts. Therefore, in a case that spatial-domain feature extraction is performed on a video frame, image data corresponding to a gray-scale value channel is obtained from image data of a plurality of channels corresponding to the video frame. In a case that the video is in the YUV format, the plurality of channels include a gray-scale value channel and a chroma channel. Further, basic feature extraction is performed on the image data corresponding to the gray-scale value channel by using the convolutional neural network unit to obtain the initial feature map.

Operation 1004: Obtain a time-domain feature vector based on the time-domain feature of the unit duration.

The time-domain feature vector is obtained based on respective corresponding time-domain features of a plurality of unit duration or all unit duration. The plurality of unit duration is part of all unit duration.

In some embodiments, operation 1004 may be implemented by the following manner: arranging each of the time-domain features (that is, respective corresponding time-domain features of a plurality of unit duration or all unit duration) in an order of the corresponding unit duration to obtain a time-domain feature sequence; collecting statistics about respective corresponding values of a plurality of time-domain feature parameters from the time-domain feature sequence; and obtaining the time-domain feature vector based on the respective values of the plurality of time-domain feature parameters.

As an example of obtaining the time-domain feature sequence, in some embodiments, to improve computing speed, obtained time-domain features may be arranged based on the order of the corresponding unit duration by marking a smooth frame as 1 and a freezing frame as 0 to obtain the time-domain feature sequence as input of time-domain data. As shown in FIG. 11, a “1001110110” binary data stream (that is, the time-domain feature sequence) may be formed, and then feature extraction is performed on the binary data stream to obtain the time-domain feature vector sequence.

As an example of collecting statistics about respective corresponding values of a plurality of time-domain feature parameters, a rule may be collected statistic based on set feature values. Statistics about respective corresponding values of the plurality of time-domain feature parameters are collected from the time-domain feature sequence. The time-domain feature vector is obtained based on the respective values of the plurality of time-domain feature parameters.

For example, the time-domain feature parameters may include at least one of the following parameters.
(1) Single freezing duration, using “1001110110” as an example, freezing occurs three times, the first freezing lasts for two-unit duration, and the second freezing and third freezing last for one-unit duration. Then, duration of each freezing may be determined based on the quantity of freezing times and a time length of each unit duration. After statistics about each freezing duration is collected, processing may also be performed on each freezing duration. For example, longest freezing duration is selected as a value of the dimension, or a mean value of each freezing duration is calculated as a value of the dimension.
(2) Long freezing duration. A long freezing event refers to an event in which freezing duration exceeds a long freezing threshold. Duration corresponding to the long freezing event is long freezing duration. The long freezing threshold may be measured experimentally. For example, the freezing duration being greater than one second belongs to a long freezing event. Similarly, after each long freezing duration is obtained, longest duration is selected as a value of the dimension, or a mean value of each long freezing duration is calculated as a value of the dimension.
(3) Long freezing times refer to a quantity of times that the long freezing event occurs.
(4) Short freezing duration. A short freezing event refers to an event in which freezing duration is less than a long freezing threshold but greater that a freezing threshold. Duration corresponding to the short freezing event is short freezing duration. For example, the freezing duration being located a range of [0.2 second, 1 second] belongs to a short freezing event.
(5) Short freezing times refer to a quantity of times that the short freezing event occurs.

Some embodiments may further include another possible time-domain feature parameter. This is not limited herein.

In some embodiments, the time-domain feature sequence may be polled. In a case that a smooth frame is converted to a freezing frame, the single freezing duration increases, a current frame state is changed, and short freezing times are increased. In a case that this freezing is determined as the long freezing, long freezing times are increased (where subsequently the long freezing times are deducted from the short freezing times), a quantity of smooth playback frames is reduced, and a time point in which the freezing event occurs is increased. In a case that the freezing state continues, the single freezing duration is continued to increase, and the quantity of smooth playback frames is reduced. In a case that a freezing frame is converted to a smooth frame, the single freezing duration for one frame is added, and the current frame state is changed.

As an example of obtaining the time-domain feature vector, after the respective values of the plurality of time-domain feature parameters are obtained, the time-domain feature vector may be obtained by splicing the values. Fluency score mapping processing may performed on the values to obtain the time-domain feature vector. After the time-domain feature sequence is formed, the trained time-domain feature extraction network may be used to perform feature extraction on the time-domain feature sequence to obtain the time-domain feature vector.

Operation 1005: Obtain a spatial-domain feature vector based on a corresponding spatial-domain feature of each video frame.

The spatial-domain feature vector is obtained based on spatial-domain features respectively corresponding to the plurality of video frames or all video frames.

In some embodiments, a corresponding spatial-domain feature vector is obtained based on each obtained spatial-domain feature by using one of the following manners:
(1) performing splicing processing on the corresponding spatial-domain feature (that is, respective corresponding spatial-domain features of a plurality of video frames or all video frames) of the video frame to obtain the spatial-domain feature vector;
(2) performing averaging processing on the corresponding spatial-domain feature (that is, respective corresponding spatial-domain features of the plurality of video frames or all video frames) of the video frame to obtain the spatial-domain feature vector; or
(3) performing pooling processing on the corresponding spatial-domain feature (that is, respective corresponding spatial-domain features of the plurality of video frames or all video frames) of the video frame to obtain the spatial-domain feature vector.

Using the averaging processing as an example, after the spatial-domain features of all frames are obtained, a mean value is taken as the spatial-domain feature vector. Some embodiments may further design a full connection layer. A quantity of input nodes of the full connection layer is a quantity of output nodes of a spatial-domain feature extraction model, and a quantity of output nodes of the full connection layer is a quantity of subjective scoring grades, such as five grades.

Operation 1006: Perform feature fusion processing on the spatial-domain feature vector and the time-domain feature vector to obtain a corresponding fusion feature vector, and determine a video quality assessment value of the online video stream based on the fusion feature vector.

As an example of determining the video quality assessment value of the online video stream, considering that a time domain is a negative effect factor on the score, the feature fusion processing may be implemented by the following manners: subtracting the time-domain feature vector from the spatial-domain feature vector to obtain the fusion feature vector; and inputting the fusion feature vector into the full connection layer to finally output the video quality assessment value.

In some embodiments, operation 1006 may be implemented by the following manner: performing feature scaling processing on the time-domain feature vector to obtain a scaled time-domain feature vector, the dimension of the scaled time-domain feature vector being consistent with a dimension of the spatial-domain feature vector; obtaining the fusion feature vector based on a difference between the spatial-domain feature vector and the scaled time-domain feature vector; and inputting the fusion feature vector into a full connection layer, and performing full connection processing on the fusion feature vector by using the full connection layer to obtain the video quality assessment value.

Refer to FIG. 5. Considering that dimensions of the time-domain feature vector and the spatial-domain feature vector are inconsistent, feature scaling processing may be performed on the time-domain feature vector, so that the dimension of the time-domain feature vector is consistent with the dimension of the spatial-domain feature vector. Then, a difference of the spatial-domain feature vector and a scaled time-domain feature vector is used as the fusion feature vector. The fusion feature vector is inputted into a full connection layer, and full connection processing is performed on the fusion feature vector by using the full connection layer to obtain the video quality assessment value.

As an example of the feature fusion processing, in some embodiments, weights may further be set for the spatial-domain feature vector and the time-domain feature vector, respectively, and then weighted summation is performed based on the weights to obtain the fusion feature vector.

The quantity of input nodes of the full connection layer is the quantity of output nodes of an upper layer (that is, the quantity of subjective scoring grades), and the quantity of output nodes is 1, that is, the video quality assessment value.

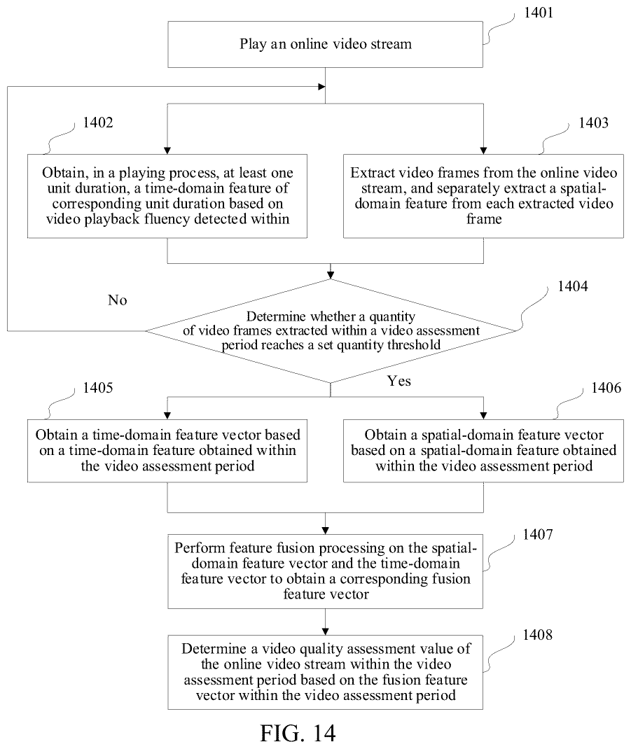

In some embodiments, considering that quality assessment is performed on the online video stream, video data is inputted frame by frame, video playback samples with short duration may be used in the training phase, but a length of the online video stream cannot be predicted. In addition, considering real time of the assessment, the overall assessment cannot be performed after the entire video completely ends, so that an entire video process needs to be assessed in segments. Therefore, FIG. 14 is a schematic flowchart of a video quality assessment method of an online video stream according to some embodiments.

Operation 1401: Play an online video stream.

Operation 1402: Obtain a time-domain feature of corresponding unit duration based on video playback fluency detected within at least one unit duration in a playing process.

Operation 1403: Extract video frames from the online video stream, and separately extract a spatial-domain feature from each extracted video frames.

Operation 1404: Determine whether a quantity of video frames extracted within a video assessment period reaches a set quantity threshold.

In some embodiments, the video quality is assessed based on the video assessment period. In other words, an assessment process is performed on a video clip, so that it is necessary to determine whether the current video assessment period ends.

The video assessment period may be preset according to an actual assessment requirement. For example, in a case that the video quality needs to be assessed every second, the video assessment period is set to every second. In a case that video quality assessment needs to be performed every 10 frames, the video assessment period is set to a quantity of extracted frames from the online video stream.

For example, it may be determined whether the quantity of extracted frames reaches a threshold. For example, in a case that the quantity of extracted frames in a video assessment period is set to N frames, it is determined whether the quantity of extracted video frames in the current video assessment period reaches N frames. If N frames are not reached, operations 1402 and 1403 are performed.

Operation 1405: In a case that the quantity of video frames extracted within the video assessment period reaches the set quantity threshold, obtain the time-domain feature vector based on time-domain features obtained within the video assessment period.

In some embodiments, operation 1405 may be implemented by the following manner: arranging each of the time-domain features (that is, respective corresponding time-domain features of a plurality of unit duration or all unit duration) obtained within the video assessment period in an order of the corresponding unit duration to obtain a time-domain feature sequence; collecting statistics about respective corresponding values of a plurality of time-domain feature parameters from the time-domain feature sequence; and obtaining the time-domain feature vector based on the respective values of the plurality of time-domain feature parameters.

As an example of obtaining the time-domain feature vector, after the respective values of the plurality of time-domain feature parameters are obtained, the time-domain feature vector may be obtained by splicing the values. Fluency score mapping processing may performed on the values to obtain the time-domain feature vector. After the time-domain feature sequence is formed, the trained time-domain feature extraction network may be used to perform feature extraction on the time-domain feature sequence to obtain the time-domain feature vector.

Operation 1406: Obtain a spatial-domain feature vector based on the spatial-domain features obtained within the video assessment period.

In some embodiments, a corresponding spatial-domain feature vector is obtained, based on each spatial-domain feature obtained within the video assessment period, by using one of the following manners:
(1) performing splicing processing on the corresponding spatial-domain feature (that is, respective corresponding spatial-domain features of a plurality of video frames or all video frames) of the video frame to obtain the spatial-domain feature vector;
(2) performing averaging processing on the corresponding spatial-domain feature (that is, respective corresponding spatial-domain features of the plurality of video frames or all video frames) of the video frame to obtain the spatial-domain feature vector; or
(3) performing pooling processing on the corresponding spatial-domain feature (that is, respective corresponding spatial-domain features of the plurality of video frames or all video frames) of the video frame to obtain the spatial-domain feature vector.

Using the averaging processing as an example, after the spatial-domain features of all frames are obtained within the video assessment period, a mean value is taken as the spatial-domain feature vector.

Operation 1407: Perform feature fusion processing on the spatial-domain feature vector and the time-domain feature vector to obtain a corresponding fusion feature vector.

Operation 1408: Determine the video quality assessment value of the online video stream within the video assessment period based on the fusion feature vector within the video assessment period.

The foregoing operations have some similarities with the embodiment shown in FIG. 10. For the similarities, refer to the foregoing description. Details are not described herein again.

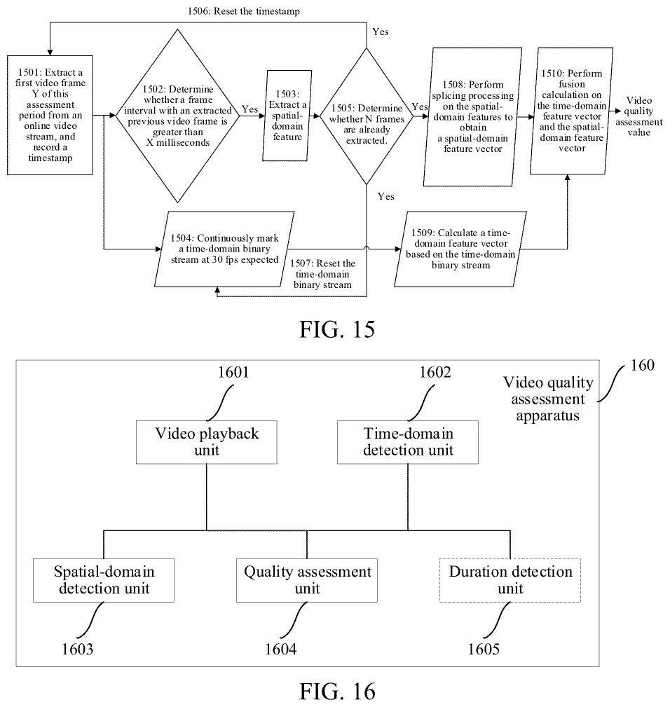

Next, refer to FIG. 15. A specific example is used to describe an assessment process of an online video stream. To reduce online occupancy, a video quality assessment model is divided into two parts (a part 1 and a part 2) at an original spatio-temporal fusion point for calculation.

Operation 1501: Extract a first video frame Y of this assessment period from an online video stream, and record a timestamp.

Operation 1502: Determine whether a frame interval with an extracted previous video frame is greater than X milliseconds.

Operation 1503: Extract a spatial-domain feature for the video frame Y if the frame interval is greater than X milliseconds.

The spatial-domain feature may be an image quality score value. In some embodiments, the spatial-domain feature may be, for example, a quality grade. In other words, the quality grade is divided into five grades based on a score value, and each grade corresponds to a scoring range.

Operation 1504: Continuously mark a time-domain binary stream at 30 fps expected.

Operation 1505: Determine whether N frames are already extracted. If yes, perform operations 1506 to 1509. If no, continue to extract frames.

Operation 1506: Reset the timestamp.

For example, the timestamp is reset to 0.

Operation 1507: Reset the time-domain binary stream.

For example, the time-domain binary stream is reset to a full 1 binary data stream.

Operation 1508: Perform splicing processing on the spatial-domain features to obtain a spatial-domain feature vector.

The image quality score mean value within the period may be calculated by using a manner of a mean value.

Operation 1509: Calculate a time-domain feature vector based on the time-domain binary stream.

Operation 1510: Perform fusion calculation on the time-domain feature vector and the spatial-domain feature vector to obtain a video quality assessment value within the period.

The foregoing operations have some similarities with the embodiment shown in FIG. 10, and refer to the foregoing description. Details are not described herein again.

The video quality assessment method in some embodiments is deployed on a video receive end and only quality of a large picture window that a user is concerned about (such as video quality of a largest window during a conference) is scored. A real-time score of a large picture is reported in the video process with a feedback every nine seconds. At the end of the conference, an average score of the entire conference and consecutive low-quality times (less than 2.25 points for 10 consecutive times) are reported. An accuracy metric comparable to a large model is obtained with a small quantity of parameters, fast speed, and small computational resource occupation that meets an application constraint.

To sum up, in the method of some embodiments, features of an online video stream in both spatial-domain and time-domain dimensions are taken into account, and the features in the two dimensions are integrated to express video quality of the online video stream, so that accuracy of video quality assessment is improved. In addition, some embodiments further implement real-time quality assessment of the online video stream, to improve real-time performance of quality assessment on the online video stream and facilitate assisting of optimization of the online video stream. In addition, by optimizing the model, such as Y channel data input, a time-domain feature extraction model, and a spatial-domain feature extraction model, occupation of resources such as a central processing unit (CPU) can be controlled within 2% when the video quality assessment model is used in.

Some embodiments verify an effect of the method according to various embodiments by comparing with another model. In an experiment, the foregoing obtained training data set is used. Training to testing ratio is selected to be 0.8/0.2. ResNet-18 is used as a baseline for VQA and is compared with the video quality assessment model (including a quantization-aware training operation, spatial-domain sampling N=12) provided in some embodiments. A comparison result is as follows:

TABLE 1

| | Common VQA | Present disclosure |
|---|---|---|
| Baseline | ResNet-18 | Video quality assessment |
| | | model |
| Input a size | Input an original size | Cut to 360 × 360 |
| Input channel | RGB 3 channel | Y channel |
| Input level | Input frame by frame, each | Input videos one by one, each |
| | frame having the same MOS | video having a total MOS |
| | as a video to which the frame | |
| | belongs | |
| Input a feature map | Spatial-domain feature only | Spatial-domain feature and |
| | | time-domain feature |
| Loss function | L1-Loss | Loss |
| Test output | Scores of each frame | Scores of each video |
| File size at client | 46.47 Mbit | 423.69 kilobit |
| PLCC/SRCC/RMSE | retrain: 0.936/0.939/0.330 | 0.941/0.940/0.350 |
| | (where there is data leakage | |
| | due to frame shuffling, so that | |
| | an actual value is to be low) | |
| Prediction time (10 s video) | Time 15 s | 1.15 s |
| CPU occupy | CPU > 5% | CPU 1.5-1.8% |

It may be learned from Table 1, a video quality assessment algorithm in some embodiments obtains an accuracy metric comparable to a large model with a small quantity of parameters, fast speed, and small CPU occupation that meets an application constraint. In addition, an actual application scenario pays special attention to low-quality video detection. The MOS is divided into grades, such as (1, 2.25] for low quality, (2.25, 3.75] for medium quality, and (3.75, 5] for high quality to determine a misdetermining rate of a high score misdetermined as a low score and 1 an omission rate of a low score misdetermined as a high score. Through verification, the algorithm in some embodiments has a low-quality misdetermining rate of close to 0, and an omission rate is about 0.8%. A misdetermining rate of another algorithm is about 0.5, and an omission rate is about 1.6%.

The technical solution of some embodiments may be applied to a real-time video communication application background for video quality assessment. For example, an average assessment score of an online conference may be detected, and a change of an assessment value of a specific device may be detected. With reference to other reported data (such as a device network state), reasons for a quality change may be excluded or roughly analyzed.

Refer to FIG. 16. Based on the same inventive concept, some embodiments further provides video quality assessment apparatus 160. The apparatus includes:

a video playback unit 1601, configured to play an online video stream; a time-domain detection unit 1602, configured to obtain a time-domain feature of corresponding unit duration based on video playback fluency detected within at least one unit duration in a process of playing the online video stream; a spatial-domain detection unit 1603, configured to extract video frames from the online video stream, and separately extract a spatial-domain feature from each extracted video frame, the time-domain detection unit 1602 being further configured to obtain a time-domain feature vector based on the time-domain feature of the unit duration, and the spatial-domain detection unit 1603 being further configured to obtain a spatial-domain feature vector based on a corresponding spatial-domain feature of each video frame; and a quality assessment unit 1604, configured to perform feature fusion processing on the spatial-domain feature vector and the time-domain feature vector to obtain a corresponding fusion feature vector, and determine a video quality assessment value of the online video stream based on the fusion feature vector.

In some embodiments, the apparatus further includes a duration detection unit 1605, configured to determine whether a quantity of video frames extracted within a video assessment period reaches a set quantity threshold. The time-domain detection unit 1602 is further configured to: in a case that the quantity of video frames extracted within the video assessment period reaches the set quantity threshold, obtain the time-domain feature vector based on time-domain features obtained within the video assessment period. The spatial-domain detection unit 1603 is further configured to obtain the spatial-domain feature vector based on spatial-domain features obtained within the video assessment period. The quality assessment unit 1604 is further configured to determine the video quality assessment value within the video assessment period based on the fusion feature vector within the video assessment period.

In some embodiments, the spatial-domain detection unit 1603 is further configured to: perform the following processing on any one of the video frames: perform basic feature extraction on the video frame by using a convolutional neural network unit to obtain an initial feature map of the video frame; and input the initial feature map to a plurality of consecutive basic mobile network units; perform the following processing by using each basic mobile network unit: perform dimensionality augmentation processing on a feature map inputted to the basic mobile network unit to obtain a first intermediate feature map, preferably perform depthwise separable convolution processing on the first intermediate feature map to obtain a second intermediate feature map, preferably further perform attention mechanism-based processing on the second intermediate feature map to obtain a third intermediate feature map, and preferably further perform residual processing on the third intermediate feature map and the feature map inputted to the basic mobile network unit to obtain a feature map outputted by the basic mobile network unit; and determine the spatial-domain feature based on a feature map outputted by the last basic mobile network unit.

In some embodiments, the spatial-domain detection unit 1603 is further configured to: obtain image data corresponding to a gray-scale value channel from image data of a plurality of channels corresponding to the video frame, the plurality of channels including the gray-scale value channel and a chroma channel; and perform basic feature extraction on the image data corresponding to the gray-scale value channel by using the convolutional neural network unit to obtain the initial feature map.

In some embodiments, the spatial-domain detection unit 1603 is further configured to: perform one of the following processing: perform splicing processing on the corresponding spatial-domain feature of the video frame to obtain the spatial-domain feature vector; perform averaging processing on the corresponding spatial-domain feature of the video frame to obtain the spatial-domain feature vector; or perform pooling processing on the corresponding spatial-domain feature of the video frame to obtain the spatial-domain feature vector.

In some embodiments, the time-domain detection unit 1602 is further configured to: perform the following processing on each unit duration: determine the video playback fluency within the unit duration based on a difference between a video frame played in the unit duration and a video frame played in at least one historical unit duration closest to the unit duration; and mark the unit duration based on the video playback fluency to obtain the time-domain feature of the corresponding unit duration, the time-domain feature of the unit duration being marked as a first value in a case that it is determined that the video playback fluency is smooth, and the time-domain feature of the unit duration being marked as a second value in a case that it is determined that the video playback fluency is freezing.

In some embodiments, the time-domain detection unit 1602 is further configured to: arrange each of the time-domain features in an order of the corresponding unit duration to obtain a time-domain feature sequence; collect statistic about respective corresponding values of a plurality of time-domain feature parameters from the time-domain feature sequence; and obtain the time-domain feature vector based on the respective values of the plurality of time-domain feature parameters.

In some embodiments, the quality assessment unit 1604 is further configured to: perform feature scaling processing on the time-domain feature vector to obtain a scaled time-domain feature vector, a dimension of the scaled time-domain feature vector being consistent with a dimension of the spatial-domain feature vector; obtain the fusion feature vector based on a difference between the spatial-domain feature vector and the scaled time-domain feature vector; and input the fusion feature vector into a full connection layer, and perform full connection processing on the fusion feature vector by using the full connection layer to obtain the video quality assessment value.

According to the foregoing apparatus, in the method of some embodiments, features of an online video stream in both spatial-domain and time-domain dimensions are taken into account, and the features in the two dimensions are integrated to express video quality of the online video stream, so that accuracy of video quality assessment is improved. In addition, some embodiments further implement real-time quality assessment of the online video stream, to improve real-time performance of quality assessment on the online video stream and facilitate assisting of optimization of the online video stream.

The apparatus may be configured to perform the video quality assessment method shown in some embodiments. Therefore, for the functions that can be implemented by functional modules of the apparatus, which are not described herein again, refer to the descriptions of the foregoing embodiments.

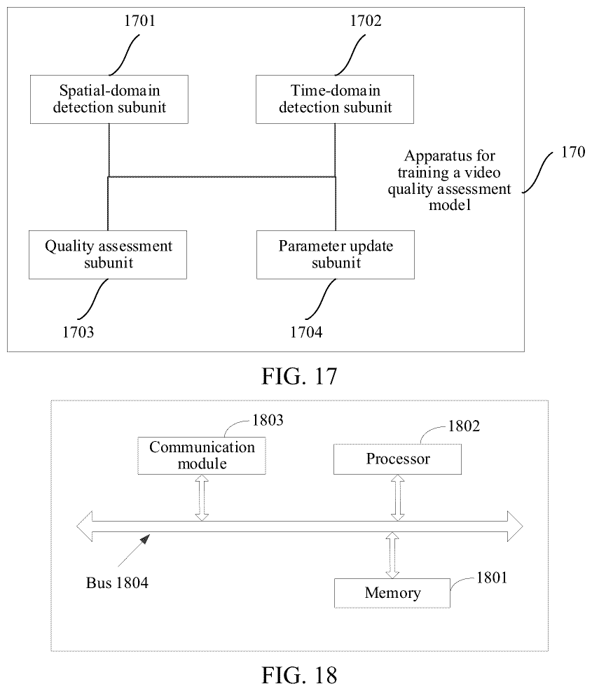

Refer to FIG. 17. Based on the same inventive concept, some embodiments further provide an apparatus for training a video quality assessment model 170. The apparatus is configured to perform a plurality of times of iterative training on the video quality assessment model by using a plurality of video playback samples, including:

a spatial-domain detection subunit 1701, configured to extract video frames from inputted video playback samples, separately perform spatial-domain feature extraction on the extracted video frames to obtain corresponding spatial-domain features, and obtain a corresponding spatial-domain feature vector based on each obtained spatial-domain feature; a time-domain detection subunit 1702, configured to obtain a time-domain feature of corresponding unit duration based on playback fluency within each unit duration in the inputted video playback samples, and obtain a time-domain feature vector based on each obtained time-domain feature; a quality assessment subunit 1703, configured to perform feature fusion processing on the spatial-domain feature vector and the time-domain feature vector to obtain a corresponding fusion feature vector, and determine a video quality assessment value based on the fusion feature vector; and a parameter update subunit 1704, configured to determine a model loss value based on video quality real values and video quality assessment values of the plurality of video playback samples, and perform model parameter update based on the model loss value.

In some embodiments, the plurality of video playback samples are obtained by recording an original video stream played by a video receive end under different video distortion simulation environments. The apparatus may further be configured to perform a plurality of times of iterative training on the video quality assessment model based on a plurality of training sample groups constructed by the plurality of video playback samples. Each training sample group includes two video playback samples originating from the same original video stream but with different video distortion simulation environment;

The parameter update subunit 1704 is further configured to determine the model loss value based on video quality real values and video quality assessment values of the video playback samples in each training sample group.

In some embodiments, the parameter update subunit 1704 is further configured to: determine a quality assessment loss value based on a video quality real value and a video quality assessment value of each video playback sample; determine a quality rank real value of the training sample group based on video quality real values of two video playback samples in each training sample group, and determine a quality rank loss value based on a difference between video quality assessment values of the two video playback samples as well as the quality rank real value; determine a quality classification loss value based on a difference between a video quality real value and a video quality assessment value of each video playback sample; and determine the model loss value based on the quality assessment loss value, the quality rank loss value, and the quality classification loss value.

In some embodiments, the parameter update subunit 1704 is further configured to: determine a first mean value of the video quality real values of the plurality of video playback samples, and determine a second mean value of the video quality assessment values of the plurality of video playback samples; perform the following processing on each of the video playback samples: determine a first difference between a video quality real value of the video playback sample and the first mean value, and determine a second difference between a video quality assessment value of the video playback sample and the second mean value; determine a batch linear loss value of each video playback sample based on a first difference value and a second difference value corresponding to the video playback sample; and determine the model loss value based on the batch linear loss value.

According to the foregoing apparatus, the idea of ranking learning is used. This can exclude a situation in which the model only learns monotonous quality information in video content, and a result is caused to be inaccurate. For example, content may be the same but predicted quality is different.

The apparatus may be configured to perform the method for training a video quality assessment model shown in some embodiments. Therefore, for the functions that can be implemented by functional modules of the apparatus, which are not described herein again, refer to the descriptions of the foregoing embodiments.

Refer to FIG. 18. Based on the same technical concept, some embodiments also provide a computer device. In an embodiment, the computer device may be the server shown in FIG. 1. The computer device, as shown in FIG. 18, includes a memory 1801, a communication module 1803, and one or more processors 1802.

The memory 1801 is configured to store a computer program executed by the processor 1802. The memory 1801 may mainly include a program storage area and a data storage arca. The program storage area may store an operating system, a program required for running an instant messaging function, and the like. The data storage area may store various instant messaging information, operation instruction sets, and the like.

The memory 1801 may be a volatile memory such as a random-access memory (RAM). The memory 1801 may be a non-volatile memory such as a read-only memory, a flash memory, a hard disk drive (HDD), or a solid-state drive (SSD). In some embodiments, the memory 1801 is any other medium that can be used to carry or store expected program codes in a form of instructions or a data structure and that can be accessed by a computer, but is not limited thereto. The memory 1801 may be a combination of the foregoing memories.

The processor 1802 may include one or more central processing units (CPU), a digital processing unit, or the like. The processor 1802 is configured to implement the foregoing video quality assessment method and the method for training a video quality assessment model when calling the computer program stored in the memory 1801.

The communication module 1803 is configured to communicate with a terminal device and another server.

A specific connection medium between the memory 1801, the communication module 1803, and the processor 1802 is not limited thereto. In some embodiments, in FIG. 18, the memory 1801 and the processor 1802 are connected via a bus 1804. The bus 1804 is described in a bold line in FIG. 18. A connection manner between other components is merely an example for description, and is not limited thereto. The bus 1804 may be classified into an address bus, a data bus, a control bus, and the like. For case of description, only one bold line is used to describe the bus in FIG. 18, but this does not mean that there is only one bus or only one type of bus.

A computer storage medium is stored in the memory 1801, and computer executable instructions are stored in the computer storage medium. The computer executable instructions are used for implementing the foregoing video quality assessment method and the method for training a video quality assessment model of some embodiments, and the processor 1802 is configured to perform the foregoing video quality assessment method and the method for training a video quality assessment model of the foregoing embodiments.

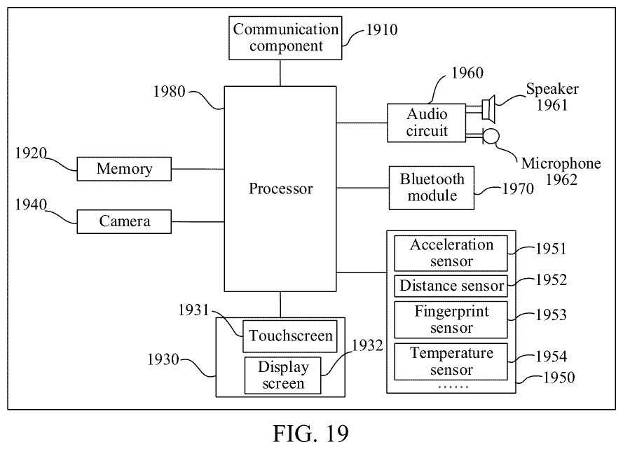

In some embodiments, the computer device may be a terminal device, such as the terminal device shown in FIG. 1. In this embodiment, the structure of the computer device may be as shown in FIG. 19, including: a communication component 1910, a memory 1920, a display unit 1930, a camera 1940, a sensor 1950, an audio circuit 1960, a Bluetooth module 1970, a processor 1980, and other components.

The communication component 1910 is configured to communicate with the server. In some embodiments, a circuit wireless fidelity (Wi-Fi) module may be included. The Wi-Fi module belongs to a short-distance wireless transmission technology, and the computer device can help a user send and receive information via the Wi-Fi module.

The memory 1920 may be configured to store a software program and data. The processor 1980 runs the software program and the data stored in the memory 1920, to implement various functions and data processing of the terminal device. The memory 1920 may include a high-speed random access memory, and may further include a non-volatile memory such as at least one magnetic disk storage device, a flash memory device, or another volatile solid storage device. The memory 1920 stores an operating system that enables the terminal device to run. In some embodiments, the memory 1920 may store the operating system and various application programs, and may also store codes that execute the foregoing video quality assessment method and the method for training a video quality assessment model of some embodiments.

The display unit 1930 may also be configured to display information inputted by the user or information provided to the user and a graphical user interface (GUI) of various menus of the terminal device. Specifically, the display unit 1930 may include a display screen 1932 disposed on the front of the terminal device. The display screen 1932 may be configured in a form of a liquid crystal display, an organic light-emitting diode, and the like. The display unit 1930 may be configured to display a video stream interface and a display interface of a video quality assessment result in some embodiments.

The display unit 1930 may also be configured to receive inputted digit or character information, and generate a signal input related to the user setting and function control of the terminal device. Specifically, the display unit 1930 may include a touchscreen 1931 disposed on the front of the terminal device, and a user's touch operation on or near the touchscreen 1931 may be collected, such as tapping a button and dragging a scroll box.

The touchscreen 1931 may be overlaid on the display screen 1932. In some embodiments, the touchscreen 1931 and the display screen 1932 may be integrated to achieve input and output functions of the terminal device, and may be referred to as a touch display screen after integration. In some embodiments, the display unit 1930 may display an application program and a corresponding operation.

The camera 1940 may be configured to capture a static image, and the user may post a comment on the image captured by the camera 1940 through the application. There may be one or more cameras 1940. An optical image of an object generated through a lens is projected to a photosensitive element. The photosensitive element may be a charge coupled device (CCD) or a complementary metal-oxide-semiconductor (CMOS) phototransistor. The photosensitive element converts an optical signal into an electrical signal, and then transmits the electrical signal to the processor 1980. The processor 1980 converts the electrical signal into a digital image signal.

The terminal device may also include at least one sensor 1950, such as an acceleration sensor 1951, a distance sensor 1952, a fingerprint sensor 1953, and a temperature sensor 1954. The terminal device may also be configured with another sensor such as a gyroscope, a barometer, a hygrometer, a thermometer, an infrared sensor, a light sensor, and a motion sensor.

The audio circuit 1960, a speaker 1961, and a microphone 1962 may provide audio interfaces between the user and the terminal device. The audio circuit 1960 may convert received audio data into an electric signal and transmit the electric signal to the speaker 1961. The speaker 1961 converts the electric signal into a sound signal and output the sound signal. The terminal device may also be configured with a volume button to adjust a volume of the sound signal. The microphone 1962 converts a collected sound signal into an electrical signal. The audio circuit 1960 receives the electrical signal, converts the electrical signal into audio data, and outputs the audio data to the communication component 1910 to be transmitted to, for example, another terminal device, or outputs the audio data to the memory 1920 for further processing.

The Bluetooth module 1970 is configured to perform information interaction with another Bluetooth device having a Bluetooth module based on a Bluetooth protocol. For example, the terminal device may establish a Bluetooth connection with a wearable computer device (such as a smartwatch) that also has a Bluetooth module via the Bluetooth module 1970 to perform data exchange.

The processor 1980 is a control center of the terminal device, and is connected to various parts of the terminal by using various interfaces and lines. By running or executing the software program stored in the memory 1920 and invoking data stored in the memory 1920, various functions and data processing of the terminal device is performed. In some embodiments, the processor 1980 may include one or more processing units. The processor 1980 may also integrate an application processor and a baseband processor. The application processor mainly processes an operating system, a user interface, an application program, and the like. The baseband processor mainly processes wireless communication. The foregoing baseband processor may either not be integrated into the processor 1980. In some embodiments, the processor 1980 may run the operating system, the application program, user interface display, touch response, and the video quality assessment method and the method for training a video quality assessment model in some embodiments. In addition, the processor 1980 is coupled with the display unit 1930.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

Based on the same inventive concept, various embodiments also provide a storage medium that stores a computer program. The computer program, when running on a computer, enables the computer to perform operations in the video quality assessment method and the method for training a video quality assessment model according to various embodiments.

In some embodiments, various aspects of the video quality assessment method and the method for training a video quality assessment model provided in some embodiments may also be implemented in a form of a computer program product, including a computer program. When the program product is run on a computer device, the computer program is used for enabling the computer device to perform the operations in the video quality assessment method and the method for training a video quality assessment model according to various embodiments described in this specification. For example, the computer device may perform the operations of each embodiment.

The program product may be any combination of one or more readable mediums. The readable medium may be a readable signal medium or a readable storage medium. The readable storage medium may be, for example, but is not limited to, electric, magnetic, optical, electromagnetic, infrared, or semiconductor systems, apparatuses, or devices, or any combination thereof. More specific example (a non-exhaustive list) of the readable storage medium include: an electrical connection having one or more wires, a portable disk, a hard disk, a random access memory (RAM), a read-only memory (ROM), an erasable programmable ROM (EPROM or a flash memory), an optical fiber, a compact disc ROM (CD-ROM), an optical storage device, a magnetic storage device, or any appropriate combination thereof.

The program product of some embodiments may adopt the portable compact disc read-only memory (CD-ROM) and include the computer program, and may be run on the computer device. However, the program product in some embodiments is not limited thereto. In some embodiments, the readable storage medium may be any tangible medium including or storing a program, and the computer program stored may be used by or used in combination with a command execution system, an apparatus, or a device.

The readable signal medium may include a data signal that is in a baseband or transmitted as a part of a carrier, and the data signal carries a readable computer program. A data signal propagated in such a way may assume a plurality of forms, including, but not limited to, an electromagnetic signal, an optical signal, or any appropriate combination thereof. The readable signal medium may be any readable medium other than a readable storage medium, and the readable medium may be used to send, propagate, or transmit a program used by or in combination with a command execution system, apparatus, or device.

The computer program included in the readable medium may be transmitted by using any suitable medium, including, but not limited to, wireless, wired, an optical cable, RF, or any appropriate combination thereof.

The computer program for performing the operation of some embodiments may be written by using any combination of one or more programming languages. The programming language includes an object-oriented programming language such as Java and C++, and includes a conventional procedural programming language such as a “C” Language or a similar programming language.

Although several units or subunits of the apparatus are mentioned in the foregoing detailed descriptions, the division is merely illustrative not mandatory. Actually, according to the some embodiments, the features and functions of two or more units described above may be specifically implemented in one unit. On the contrary, the features and functions of one unit described above may be further divided to be embodied by a plurality of units.

In addition, although the operations of the method in some embodiments are described in a specific order in the accompanying drawings, this does not require or imply that the operations are bound to be performed in the specific order, or all the operations shown are bound to be performed to achieve the expected result. Some operations may be omitted, a plurality of operations may be combined into one operation for execution, and/or one operation may be decomposed into a plurality of operations for execution.

A person skilled in the art is to be understood that various embodiments may be provided as a method, a system, or a computer program product. Therefore, various embodiments may use a form of hardware-only embodiments, software-only embodiments, or embodiments combining software and hardware. Moreover, some embodiments may use a form of a computer program product that is implemented on one or more computer-usable storage media (including but not limited to a magnetic disk storage, a CD-ROM, an optical memory, and the like) that include computer-usable program code.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A video quality assessment method, performed by a computer device, comprising:
playing an online video stream;
obtaining a time-domain feature of a corresponding unit of duration based on video playback fluency detected within at least one unit of duration in a process of playing the online video stream;
extracting video frames from the online video stream, and separately extracting a spatial-domain feature from each extracted video frame;
obtaining a time-domain feature vector based on the time-domain feature of the unit of duration, and obtaining a spatial-domain feature vector based on a corresponding spatial-domain feature of each video frame; and
performing feature fusion processing on the spatial-domain feature vector and the time-domain feature vector to obtain a fusion feature vector, and determining a video quality assessment value of the online video stream based on the fusion feature vector.

2. The video quality assessment method according to claim 1, further comprising:
determining whether a quantity of video frames extracted within a video assessment period reaches a set quantity threshold;
wherein obtaining the time-domain feature vector comprises:
based on the quantity of video frames extracted within the video assessment period reaching the set quantity threshold, obtaining the time-domain feature vector based on time-domain features obtained within the video assessment period, and obtaining the spatial-domain feature vector based on spatial-domain features obtained within the video assessment period; and
wherein determining the video quality assessment value comprises:
determining the video quality assessment value within the video assessment period based on the fusion feature vector within the video assessment period.

3. The video quality assessment method according to claim 1, wherein separately extracting the spatial-domain feature from each extracted video frame comprises:
performing the following processing on any one of the video frames:
performing basic feature extraction on the video frame by using a convolutional neural network to obtain an initial feature map of the video frame;
inputting the initial feature map to a plurality of consecutive basic mobile networks;
performing the following processing by using each basic mobile network of the plurality of consecutive basic mobile networks:
performing dimensionality augmentation processing on a feature map inputted to the basic mobile network to obtain a first intermediate feature map,
performing depthwise separable convolution processing on the first intermediate feature map to obtain a second intermediate feature map,
performing attention mechanism-based processing on the second intermediate feature map to obtain a third intermediate feature map, and
performing residual processing on the third intermediate feature map and the feature map inputted to the basic mobile network to obtain a feature map outputted by the basic mobile network; and
determining the spatial-domain feature based on a feature map outputted by a last basic mobile network.

4. The video quality assessment method according to claim 3, wherein the performing basic feature extraction on the video frame by using the convolutional neural network comprises:
obtaining image data corresponding to a gray-scale value channel from image data of a plurality of channels corresponding to the video frame, the plurality of channels comprising the gray-scale value channel and a chroma channel; and
performing basic feature extraction on the image data corresponding to the gray-scale value channel by using the convolutional neural network to obtain the initial feature map.

5. The video quality assessment method according to claim 1, wherein obtaining the spatial-domain feature vector based on the corresponding spatial-domain feature of each video frame comprises:
performing one of the following processing:
performing splicing processing on the corresponding spatial-domain feature of the video frame to obtain the spatial-domain feature vector;
performing averaging processing on the corresponding spatial-domain feature of the video frame to obtain the spatial-domain feature vector; or
performing pooling processing on the corresponding spatial-domain feature of the video frame to obtain the spatial-domain feature vector.

6. The video quality assessment method according to claim 1, wherein obtaining the time-domain feature of the corresponding unit of duration based on video playback fluency detected within at least one unit of duration comprises:
performing the following processing on each unit of duration:
determining the video playback fluency within the unit of duration based on a difference between a video frame played in the unit of duration and a video frame played in at least one historical unit of duration closest to the unit of duration; and
marking the unit of duration based on the video playback fluency to obtain the time-domain feature of the corresponding unit of duration, the time-domain feature of the unit of duration being marked as a first value based on a determination that the video playback fluency is smooth, and the time-domain feature of the unit of duration being marked as a second value based on a determination that the video playback fluency is freezing.

7. The video quality assessment method according to claim 1, wherein obtaining the time-domain feature vector comprises:
arranging each of the time-domain features in an order of the corresponding unit of duration to obtain a time-domain feature sequence;
collecting statistic about respective corresponding values of a plurality of time-domain feature parameters from the time-domain feature sequence; and
obtaining the time-domain feature vector based on the respective values of the plurality of time-domain feature parameters.

8. The video quality assessment method according to claim 1, wherein performing feature fusion processing on the spatial-domain feature vector and the time-domain feature vector to obtain the fusion feature vector, and determining the video quality assessment value of the online video stream based on the fusion feature vector comprises:
performing feature scaling processing on the time-domain feature vector to obtain a scaled time-domain feature vector, a dimension of the scaled time-domain feature vector being consistent with a dimension of the spatial-domain feature vector;
obtaining the fusion feature vector based on a difference between the spatial-domain feature vector and the scaled time-domain feature vector; and
inputting the fusion feature vector into a full connection layer, and performing full connection processing on the fusion feature vector by using the full connection layer to obtain the video quality assessment value.

9. A video quality assessment apparatus, comprising:
at least one memory configured to store program code; and
at least one processor configured to read the program code and operate as instructed by the program code, the program code comprising:
video playback code configured to cause at least one of the at least one processor to play an online video stream;
time-domain detection code configured to cause at least one of the at least one processor to obtain a time-domain feature of a corresponding unit of duration based on video playback fluency detected within at least one unit of duration in a process of playing the online video stream;
spatial-domain detection code configured to cause at least one of the at least one processor to extract video frames from the online video stream, and separately extract a spatial-domain feature from each extracted video frame,
the time-domain detection code being further configured to cause at least one of the at least one processor to obtain a time-domain feature vector based on the time-domain feature of the unit of duration, and
the spatial-domain detection code being further configured to cause at least one of the at least one processor to obtain a spatial-domain feature vector based on a corresponding spatial-domain feature of each video frame; and
quality assessment code configured to cause at least one of the at least one processor to perform feature fusion processing on the spatial-domain feature vector and the time-domain feature vector to obtain a fusion feature vector, and determine a video quality assessment value of the online video stream based on the fusion feature vector.

10. The video quality assessment apparatus according to claim 9, wherein the program code further comprises detection code configured to cause at least one of the at least one processor to determine whether a quantity of video frames extracted within a video assessment period reaches a set quantity threshold;
wherein the time-domain detection code is further configured to cause at least one of the at least one processor to, based on the quantity of video frames extracted within the video assessment period reaching the set quantity threshold, obtain the time-domain feature vector based on time-domain features obtained within the video assessment period;
wherein the spatial-domain detection code is further configured to cause at least one of the at least one processor to obtain the spatial-domain feature vector based on spatial-domain features obtained within the video assessment period; and
wherein the quality assessment code is further configured to cause at least one of the at least one processor to determine the video quality assessment value within the video assessment period based on the fusion feature vector within the video assessment period.

11. The video quality assessment apparatus according to claim 9, wherein the spatial-domain detection code is further configured to cause at least one of the at least one processor to:
perform the following processing on any one of the video frames:
perform basic feature extraction on the video frame by using a convolutional neural network to obtain an initial feature map of the video frame;
input the initial feature map to a plurality of consecutive basic mobile networks;
perform the following processing by using each basic mobile network of the plurality of consecutive basic mobile networks:
perform dimensionality augmentation processing on a feature map inputted to the basic mobile network to obtain a first intermediate feature map,
perform depthwise separable convolution processing on the first intermediate feature map to obtain a second intermediate feature map,
perform attention mechanism-based processing on the second intermediate feature map to obtain a third intermediate feature map, and
perform residual processing on the third intermediate feature map and the feature map inputted to the basic mobile network to obtain a feature map outputted by the basic mobile network; and
determine the spatial-domain feature based on a feature map outputted by a last basic mobile network.

12. The video quality assessment apparatus according to claim 11, wherein the spatial-domain detection code is further configured to cause at least one of the at least one processor to:
obtain image data corresponding to a gray-scale value channel from image data of a plurality of channels corresponding to the video frame, the plurality of channels comprising the gray-scale value channel and a chroma channel; and
perform basic feature extraction on the image data corresponding to the gray-scale value channel by using the convolutional neural network to obtain the initial feature map.

13. The video quality assessment apparatus according to claim 9, wherein the spatial-domain detection code is further configured to cause at least one of the at least one processor to:
perform one of the following processing:
perform splicing processing on the corresponding spatial-domain feature of the video frame to obtain the spatial-domain feature vector;
perform averaging processing on the corresponding spatial-domain feature of the video frame to obtain the spatial-domain feature vector; or
perform pooling processing on the corresponding spatial-domain feature of the video frame to obtain the spatial-domain feature vector.

14. The video quality assessment apparatus according to claim 9, wherein the time-domain detection code is further configured to cause at least one of the at least one processor to:
perform the following processing on each unit of duration:
determine the video playback fluency within the unit of duration based on a difference between a video frame played in the unit of duration and a video frame played in at least one historical unit of duration closest to the unit of duration; and
mark the unit of duration based on the video playback fluency to obtain the time-domain feature of the corresponding unit of duration, the time-domain feature of the unit of duration being marked as a first value based on a determination that the video playback fluency is smooth, and the time-domain feature of the unit of duration being marked as a second value based on a determination that the video playback fluency is freezing.

15. The video quality assessment apparatus according to claim 9, wherein the time-domain detection code is further configured to cause at least one of the at least one processor to:
arrange each of the time-domain features in an order of the corresponding unit of duration to obtain a time-domain feature sequence;
collect statistic about respective corresponding values of a plurality of time-domain feature parameters from the time-domain feature sequence; and
obtain the time-domain feature vector based on the respective values of the plurality of time-domain feature parameters.

16. The video quality assessment apparatus according to claim 9, wherein the quality assessment code is further configured to cause at least one of the at least one processor to:
perform feature scaling processing on the time-domain feature vector to obtain a scaled time-domain feature vector, a dimension of the scaled time-domain feature vector being consistent with a dimension of the spatial-domain feature vector;
obtain the fusion feature vector based on a difference between the spatial-domain feature vector and the scaled time-domain feature vector; and
input the fusion feature vector into a full connection layer, and perform full connection processing on the fusion feature vector by using the full connection layer to obtain the video quality assessment value.

17. A non-transitory computer-readable storage medium, storing computer code which, when executed by at least one processor, causes the at least one processor to at least:
play an online video stream;
obtain a time-domain feature of a corresponding unit of duration based on video playback fluency detected within at least one unit of duration in a process of playing the online video stream;
extract video frames from the online video stream, and separately extract a spatial-domain feature from each extracted video frame;
obtain a time-domain feature vector based on the time-domain feature of the unit of duration, and obtain a spatial-domain feature vector based on a corresponding spatial-domain feature of each video frame; and
perform feature fusion processing on the spatial-domain feature vector and the time-domain feature vector to obtain a fusion feature vector, and determine a video quality assessment value of the online video stream based on the fusion feature vector

18. The non-transitory computer-readable storage medium according to claim 17, wherein the computer code further causes the at least one processor to at least:
determine whether a quantity of video frames extracted within a video assessment period reaches a set quantity threshold;
wherein the obtain the time-domain feature vector comprises:
based on the quantity of video frames extracted within the video assessment period reaching the set quantity threshold, obtaining the time-domain feature vector based on time-domain features obtained within the video assessment period, and obtaining the spatial-domain feature vector based on spatial-domain features obtained within the video assessment period; and
wherein the determine the video quality assessment value comprises:
determining the video quality assessment value within the video assessment period based on the fusion feature vector within the video assessment period.

19. The non-transitory computer-readable storage medium according to claim 17, wherein the separately extract the spatial-domain feature from each extracted video frame comprises:
performing the following processing on any one of the video frames:
performing basic feature extraction on the video frame by using a convolutional neural network to obtain an initial feature map of the video frame;
inputting the initial feature map to a plurality of consecutive basic mobile networks;
performing the following processing by using each basic mobile network of the plurality of consecutive basic mobile networks:
performing dimensionality augmentation processing on a feature map inputted to the basic mobile network to obtain a first intermediate feature map,
performing depthwise separable convolution processing on the first intermediate feature map to obtain a second intermediate feature map,
performing attention mechanism-based processing on the second intermediate feature map to obtain a third intermediate feature map, and
performing residual processing on the third intermediate feature map and the feature map inputted to the basic mobile network to obtain a feature map outputted by the basic mobile network; and
determining the spatial-domain feature based on a feature map outputted by a last basic mobile network.

20. The non-transitory computer-readable storage medium according to claim 19, wherein the perform basic feature extraction on the video frame by using the convolutional neural network comprises:
obtaining image data corresponding to a gray-scale value channel from image data of a plurality of channels corresponding to the video frame, the plurality of channels comprising the gray-scale value channel and a chroma channel; and
performing basic feature extraction on the image data corresponding to the gray-scale value channel by using the convolutional neural network to obtain the initial feature map.
